(19) United States
(12) Patent Application Publication
(10) Pub. No.: US 2016/0176036 A1
(43) Pub. Date: Jun. 23, 2016

(54) Multi-Purpose Tool and Tool Attachments

(71) Applicant: SERE INDUSTRIES INC., Mission Viejo, CA (US)

(72) Inventor: Timothy M. Langan, Mission Viejo, CA (US)

(21) Appl. No.: 14/902,817

(22) PCT Filed: Jul. 3, 2014
(86) PCT No.: PCT/US14/45496

§ 371 Date: Jan. 4, 2016

Related U.S. Application Data
(60) Provisional application No. 61/842,925, filed on Jul. 3, 2013.

(51) Int. Cl. B25F 1/02; B25D 7/00; A42B 3/04; B25J 1/04; A01B 1/08; B25D 1/04; B25F 1/00

(52) U.S. Cl. CPC B25F 1/02; B25D 1/04; B25D 7/00; B25F 1/006; B25J 1/04; A01B 1/08; A42B 3/0406

(57) ABSTRACT

A multi-purpose tool and tool attachments have been described. The multi-purpose tool comprises a utility bar that has an elongated structural member partly covered by an overmold, and universal connectors on its two ends. The cross section of the elongated member is crossed-shaped and has a plurality of recesses, which helps to optimize the weight-to-strength ratio of the bar. The universal connectors are male and female snap-fit engagements that allow for different tool attachments to be quickly and easily attached to the ends of the bar in both a right-hand and left-hand orientation. The connectors also allow several utility bars to be connected in series to make a longer utility bar. The tool attachments comprise a handle-hammer-pick attachment, a shovel head counterweight, a spear head, an extractor attachment, a breaching tool attachment, and a monopod sniper attachment. Each tool attachment is designed to have multiple functions.

### FIELD OF THE INVENTION

The field of the invention is multi-purpose tools and tool attachments.

### BACKGROUND

The background description includes information that may be useful in understanding the present invention. It is not an admission that any of the information provided herein is prior art or relevant to the presently claimed invention, or that any publication specifically or implicitly referenced is prior art.

Various configurations of multi-purpose tools are known. U.S. Pat. No. 576,756, for example, discloses a “combination tool,” that has a bar with threaded ends and various tool attachments (e.g., spade, hammer, pick, hatchet, etc.) that can be threadably coupled to the ends of the bar. The interchangeable tool attachments advantageously provide multiple functions for the combination tool, thus reducing weight and space. Unfortunately, the threaded connectors of the combination tool do not allow for both a left-hand and a right-hand orientation of tool attachments because the threaded connectors are unidirectional. Moreover, the threaded connectors take time to attach and detach different tool attachments and do not always orient the tool attachments in a consistent manner (e.g., the T-union handle attachment may not always be oriented in plane with the spade attachment if either attachment is over rotated or if the threads are worn). It would be advantageous to provide a multi-purpose tool and tool attachments that can be used in a left-hand and right-hand orientation and that have quick-release fasteners for easily swapping out different tool attachments with the bar.

Other examples of multi-purpose tools and tool attachments are found in U.S. Pat. Nos. 3,219,316, 4,700,420, 5,799,996, 6,671,913, 6,948,208, and 7,219,382. Also see US Patent Publication No. US 2010/0263133, which is the inventor's prior work.

Unfortunately, these configurations and designs also suffer from one or more of the drawbacks discussed above. In addition, these references and many other known configurations for multi-purpose tools and tool attachments have very limited function. For example, a spade attachment typically will have just one function (e.g., shovel) and a hammer attachment typically will have just two functions (e.g., hammer and nail remover). In addition, the bar itself typically does not server any function other than as a handle or connector for attaching different tool attachments. It would be advantageous to provide a multi-purpose tool in which each tool attachment has a plurality of different and unrelated functions and in which the bar itself serves multiple functions.

It would also be advantageous to provide a design for a utility bar that optimizes the following characteristics: (i) light weight; (ii) compact; (ii) high strength; (iii) multiply utilities. These objectives are particularly important in applications such as emergency rescue (e.g., fire fighters, law enforcement), mountaineering/backpacking/camping, military, and aerospace, since weight and space are very limited.

These objectives are optimized to some extent in US Patent Publication No. 2012/0098282 (the '282 Publication), which is the inventor's own work. In particular, the '282 Publication describes a utility bar that has an elongated structural member covered by an overmold. The elongated member is light weight and has very high strength (e.g., flexural strength, fracture toughness, hardness, etc.), due, in part, to its cross sectional shape and staggered recessed portions. The overmold provides a comfortable gripping surface that helps to absorb shock forces. While the utility bar described in the '282 Publication is advantageous in many aspects, it would be beneficial to provide additional utility bar designs and configurations that further optimize these objectives.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved multi-purpose tools and tool attachments.

### SUMMARY OF THE INVENTION

The inventive subject matter provides apparatus, systems and methods in which a multi-purpose tool comprises a utility bar with universal connectors at each of its two ends. The universal connectors allow for different tool attachments to be quickly and easily attached to the bar, in both a left-handed and a right-handed configuration. The bar is made of an elongated structural member that is covered by an overmold. In some embodiments, the elongated structural member is made of a metal allow. The overmold is made of a softer material, such as a rubber, which helps to absorb shock/impact forces and is more comfortable to grip.

In one aspect of some embodiments, the elongated member has a plurality of recesses to provide for mechanical engagement with the overmold. The recesses and cross-shaped cross-sectional area of the elongated member also help to improve strength-to-weight ratio of the utility bar.

In another aspect of some embodiments, the universal connectors of the utility bar are male and female connectors/fasteners. In such embodiments, one end of the bar has a male protrusion that is sized and dimensioned to fit into, and lock with, a female cavity on the other end of the bar. This allows for multiple utility bars to be connected in series. The cross sectional shape of the male protrusion (and female cavity) can be shaped to allow for tool attachments to be coupled with the bar in both a right-hand and left-hand orientation. For example, the cross section can be a circular or oval shape with two flat opposing sides (e.g., double D-shaped).

The inventive subject matter provides apparatus, systems and methods in which handle attachment comprises a t-shaped member having a handle portion and a stem portion. The stem portion extends from the handle portion. The handle portion has a blunt end for hammering and a pointed end for picking. The handle portion also has one or more through holes that provide attachment points and which help to reduce the weight of the handle attachment.

In one aspect of some embodiments, pointed end is longer than the blunted end to provide additional leverage for picking and prying. In other aspects of some embodiments, the handle portion is curved downward (e.g., concave towards the stem portion) to provide better ergonomics for gripping when used as a handle.

The stem portion of the handle attachment has a universal connector that can be used to quickly and easily couple the handle attachment to the utility bar described above. In some embodiments, the stem portion may also have one or more through holes that can be used as attachment points.

The inventive subject matter provides apparatus, systems and methods in which a helmet counterweight for counterbalancing a helmet attachment (e.g., night vision goggles, etc.) on a helmet is designed to induce minimal stress on the user's neck. In one aspect, the reduced neck stress is achieved by distributing the mass of the counterweight across a larger surface area of the helmet. By spreading the mass across a larger surface area, the moment of force (e.g., torque) vectors (relative to the user's neck) are also spread out. This helps to reduce stress on the user's neck, in part because the spread out vectors cancel or reduce one another. In another aspect of the inventive subject matter, the reduced neck stress is achieved by the counterweight's low profile, which reduces the distance of the mass to the neck. By keeping the mass closer to the user's neck, the torque on the neck is also reduced. The counterweight can include a hook and loop fastener on its underside surface so that it can be removably and repositionably attached to the helmet. In addition, the counterweight includes two or more universal connectors for coupling a utility bar in two distinct configurations.

The inventive subject matter provides apparatus, systems and methods in which a multi-purpose spear tool attachment can provide users (e.g., military, firefighters and rescue personnel) with a convenient multi-tool for various tasks. Contemplated systems and methods include a spear tool attachment having a first end portion and a second end portion. The first end portion has a point, and the second end portion has a universal connector. The spear tool attachment further comprises an intermediate portion between the first end portion and the second end portion. The intermediate portion has a stepped opening having a plurality of steps that define a plurality of distinct widths. It should be appreciated that the plurality of distinct widths allow the spear tool attachment to engage a ⅝ inch, ½ inch, 7/16 inch, ⅜ inch, and 5/16 inch hex nut and a rectangular-shaped shutoff value. The stepped opening also has a first side and a second side that intersect near at an acute angle near the first end portion.

The inventive subject matter provides apparatus, systems and methods in which a multi-purpose extractor tool attachment can provide users with various functionalities (e.g., prying, twisting, punching, striking, etc.). Contemplated systems and methods include an extractor tool attachment having a first segment and a second segment having a universal connector. The first segment and the second segment meet at a first angle (e.g., 10°) for optimal prying, striking or twisting. Moreover, the tool has a width that narrows from the second segment to the first segment. In addition, the tool attachment has two wings to strike, chop, chisel, poke, and the like.

The inventive subject matter provides apparatus, systems and methods in which a breaching tool attachment comprises a t-shape member that has a head portion and stem portion extending from the head portion. The head portion has a blunt end for hammering and a claw end for removing nails and/or prying. The head portion also includes one or more through holes that function as attachment points and that help to reduce the weight of the breaching tool attachment. In some embodiments, the claw end comprises two fingers that meet to form a v-notch. The stem portion of the breaching tool attachment includes a universal connector that mates with a utility bar. The stem portion may also include one or more through holes that serve as attachment points. In other aspects of some embodiments, the head portion has a recess on the right side and a recess on the left side.

The inventive subject matter provides apparatus, systems and methods in which an adaptor attachment comprises a mounting platform and a universal connector extending from a side of the mounting platform. The universal connector can be coupled with a utility bar to provide a mounting platform that can be used to attach other devices such as flashlights, cameras, and guns. The mounting platform can include a flat surface for resting other devices. The mounting platform may also include bolts, holes, attachment points, and other features that facilitate attachment of another device.

The inventive subject matter provides apparatus, systems and methods in which a cutting device attachment comprising two sharp-edged components that are rotatably coupled. Each sharp-edge component has a universal connector that mates with one of the connectors of a utility bar. When a utility bar (or series of utility bars) is coupled to each sharp-edge component, the combination can be used as a cutting tool.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a perspective view of one embodiment of a multi-purpose utility bar.

FIG. 2 is a top view of the bar of FIG. 1.

FIG. 3 is a bottom view of the bar of FIG. 1.

FIG. 4a is a left side view of the bar of FIG. 1., the right side view being a mirror image.

FIG. 4b is a close-up perspective view of the end the bar of FIG. 1, with a double detent spring mechanism.

FIG. 4c shows the bar and double detent spring mechanism of FIG. 4b, the end of the bar shown as transparent to better illustrate the spring mechanism.

FIG. 5 is a cross section view taken along line A-A of FIG. 2.

FIG. 6 is a cross section view taken along line D-D of FIG. 2.

FIG. 7 is a cross section view taken along line E-E of FIG. 2.

FIG. 8a is a perspective view of multiple utility bars connected in series.

FIG. 8b is a close up, cross sectional view taken along line A-A in FIG. 8a.

FIG. 9 shows one embodiment of a carrying apparatus, which utilizes the utility bar of FIG. 1.

FIG. 10 shows one application for the utility bar of FIG. 1.

FIG. 11 shows one embodiment of a gurney, which utilizes the utility bar of FIG. 1.

FIG. 12 shows the gurney of FIG. 11 being used by military personnel.

FIG. 13 shows one embodiment of a stint, which utilizes the utility bar of FIG. 1.

FIG. 14 is a perspective view of the overmold of the utility bar of FIG. 1.

FIG. 15 is a perspective view of the elongated structural member of the utility bar of FIG. 1.

FIG. 16 is a top view of the elongated structural member of the utility bar of FIG. 1.

FIG. 17 is a right side view of the elongated structural member of the utility bar of FIG. 1.

FIG. 18 is a bottom view of the elongated structural member of the utility bar of FIG. 1.

FIG. 19 is a left side view of the elongated structural member of the utility bar of FIG. 1.

FIG. 20 is a back view of the elongated structural member of the utility bar of FIG. 1.

FIG. 21 is a front view of the elongated structural member of the utility bar of FIG. 1.

FIG. 22 is a cross section view taken along line A-A of FIG. 16.

FIG. 23 is a cross section view taken along line B-B of FIG. 16.

FIG. 24 is a cross section view taken along line C-C of FIG. 17.

FIG. 25 is a cross section view taken along line E-E of FIG. 16.

FIG. 26 is a cross section view taken along line F-F of FIG. 16.

FIG. 27 is a cross section view taken along line G-G of FIG. 16.

FIG. 28 is a top perspective view of one embodiment of a handle attachment.

FIG. 29 is a bottom perspective view of the handle attachment of FIG. 28.

FIG. 30 is a front view of the handle attachment of FIG. 28.

FIG. 31 is a right side view of the handle attachment of FIG. 28, the left side being a mirror image.

FIG. 32 is a back view of the handle attachment of FIG. 28.

FIG. 33 is a top view of the handle attachment of FIG. 28.

FIG. 34 is a cross section view taken along line A-A of FIG. 31.

FIG. 35 is a cross section view taken along line B-B of FIG. 31.

FIG. 36 is a front view of the handle of FIG. 28 in combination with a grapple attachment.

FIG. 37 is a perspective view of the utility bar of FIG. 1 in combination with the handle attachment of FIG. 28 and the counterweight attachment of FIG. 40.

FIG. 38 is a perspective view of the tool of FIG. 37, wherein the handle is attached to the utility bar in a right-handed configuration.

FIG. 39 is a perspective view of the tool of FIG. 37, wherein the handle is attached to the utility bar in a left-handed configuration.

FIG. 40 is a back, perspective view of a helmet with a shovel head counterweight attached to the helmet.

FIG. 41 is a side view of a person wearing the helmet and counterweight of FIG. 40.

FIG. 42 is a top view of the counterweight of FIG. 40.

FIG. 43 is a bottom view of the counterweight of FIG. 40.

FIG. 44 is a left side view of the counterweight of FIG. 40.

FIG. 45 is a front view of the counterweight of FIG. 40.

FIG. 46 is a back view of the counterweight of FIG. 40.

FIG. 47 is a cross section view taken along line A-A of FIG. 46.

FIG. 48 is a close-up perspective view of the counterweight of FIG. 40 attached to the utility bar of FIG. 1 in a digging configuration.

FIG. 49 is a close-up perspective view of the counterweight of FIG. 40 attached to the utility bar of FIG. 1 in a scooping configuration.

FIG. 50 is a close-up perspective view of the counterweight of FIG. 40 attached to the utility bar of FIG. 1 in a standing monopod configuration.

FIG. 51 is a perspective view of one embodiment of an spear tool attachment.

FIG. 52 is a top view of the spear tool attachment of FIG. 51.

FIG. 53 is a right side view of the spear tool attachment of FIG. 51.

FIG. 54 is a back view of the spear tool attachment of FIG. 51.

FIG. 55 is a cross section view along line A-A of FIG. 52.

FIG. 56 is another top view of the spear tool attachment of FIG. 51, showing hex nut sizes that fit inside stepped opening of the spear tool attachment.

FIG. 57 is a perspective view of the spear tool attachment of FIG. 51 in combination with a utility bar and handle attachment.

FIG. 58 is a perspective view of one embodiment of an extractor tool attachment.

FIG. 59 is a front view of the extractor tool attachment of FIG. 58.

FIG. 60 is a back view of the extractor tool attachment of FIG. 58.

FIG. 61 is a side view of the extractor tool attachment of FIG. 58.

FIG. 62 is a top view of the extractor tool attachment of FIG. 58.

FIG. 63 is a cross section view along line A-A of FIG. 62.

FIG. 64 is a cross section view along line B-B of FIG. 62.

FIG. 65 is a perspective view of the extractor tool attachment of FIG. 58 in combination with a utility bar and a handle attachment.

FIG. 66 is a perspective view of one embodiment of a breaching tool attachment.

FIG. 67 is a left side view of the breaching tool attachment of FIG. 66.

FIG. 68 is a top side view of the breaching tool attachment of FIG. 66.

FIG. 69 is a bottom view of the breaching tool attachment of FIG. 66.

FIG. 70 is a front view of the breaching tool attachment of FIG. 66.

FIG. 71 is a right side view of the breaching tool attachment of FIG. 66.

FIG. 72 is a back view of the breaching tool attachment of FIG. 66.

FIG. 73 is cross section view along line A-A of FIG. 71.

FIG. 74 is cross section view along line B-B of FIG. 72.

FIG. 75 is cross section view along line C-C of FIG. 74.

FIG. 76 is a perspective view of the breaching tool of FIG. 66 in combination with a utility bar.

FIG. 77 is a perspective view of one embodiment of an adaptor attachment.

FIG. 78 is a bottom view of the adaptor attachment of FIG. 77.

FIG. 79 is a top view of the adaptor attachment of FIG. 77.

FIG. 80 is a front side view of the adaptor attachment of FIG. 77, the back side view being a mirror image.

FIG. 81 is a right side view of the adaptor attachment of FIG. 77, the left side view being a mirror image.

FIG. 82 is a perspective view of the adaptor attachment of FIG. 77 in combination with a utility bar.

FIG. 83 is a perspective view of the adaptor attachment of FIG. 77 in combination with a utility bar and a rifle.

FIG. 84 is a perspective view of one embodiment of a cutter tool attachment in combination with two utility bars.

FIGS. 85-93 show schematics with dimensions for one embodiment of a utility bar, handle attachment, spear attachment, extractor attachment, and breaching tool attachment.

### DETAILED DESCRIPTION

The following description includes information that may be useful in understanding the present invention. It is not an admission that any of the information provided herein is prior art or relevant to the presently claimed invention, or that any publication specifically or implicitly referenced is prior art.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

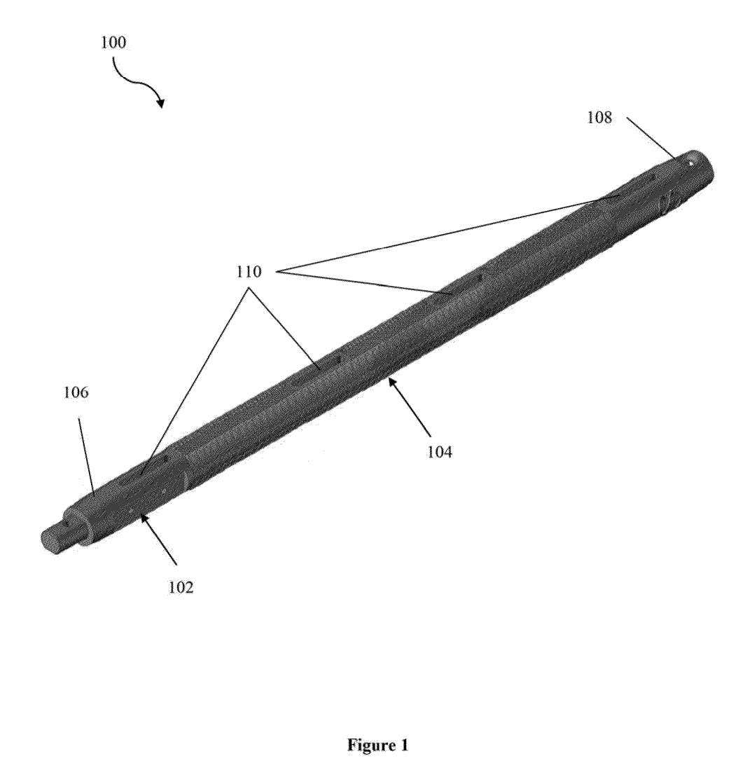

FIG. 1 is a perspective view of a multi-purpose utility bar 100. Bar 100 has an elongated structural member 102 and an overmold 104 covering part of member 102. Bar 100 also has a first universal connector 106 and a second universal connector 108. In addition, bar 100 has a plurality of through holes 110.

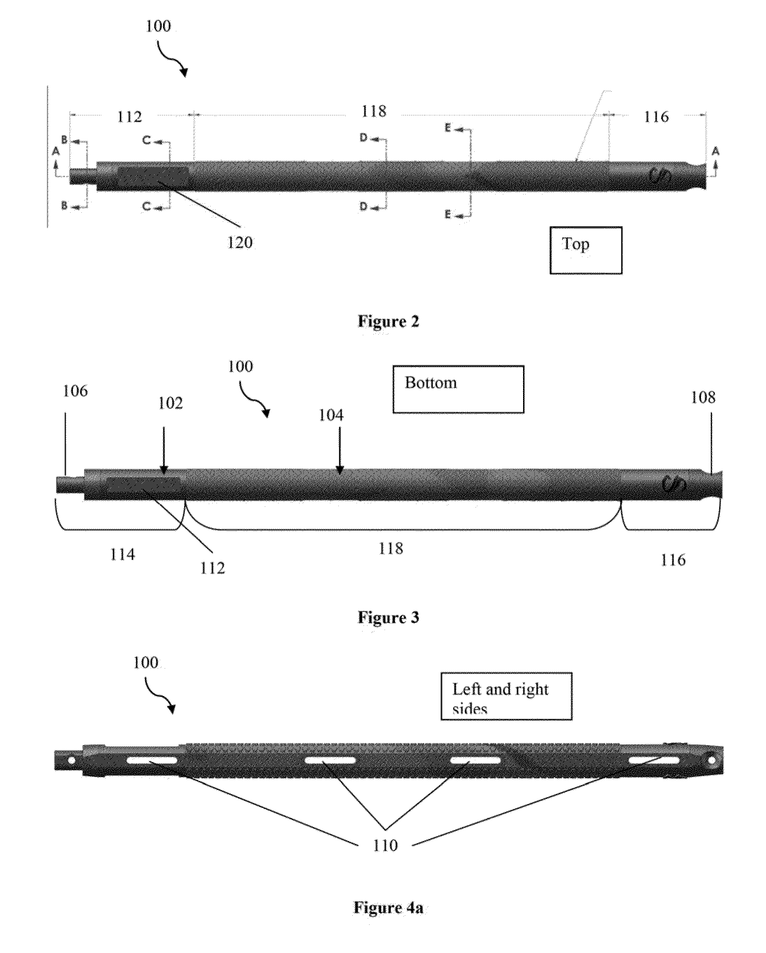

FIG. 2 is a top view of the bar of FIG. 1. Bar 100 has an end portion 114, end portion 116, and a middle section 118 between end portions 114, 116.

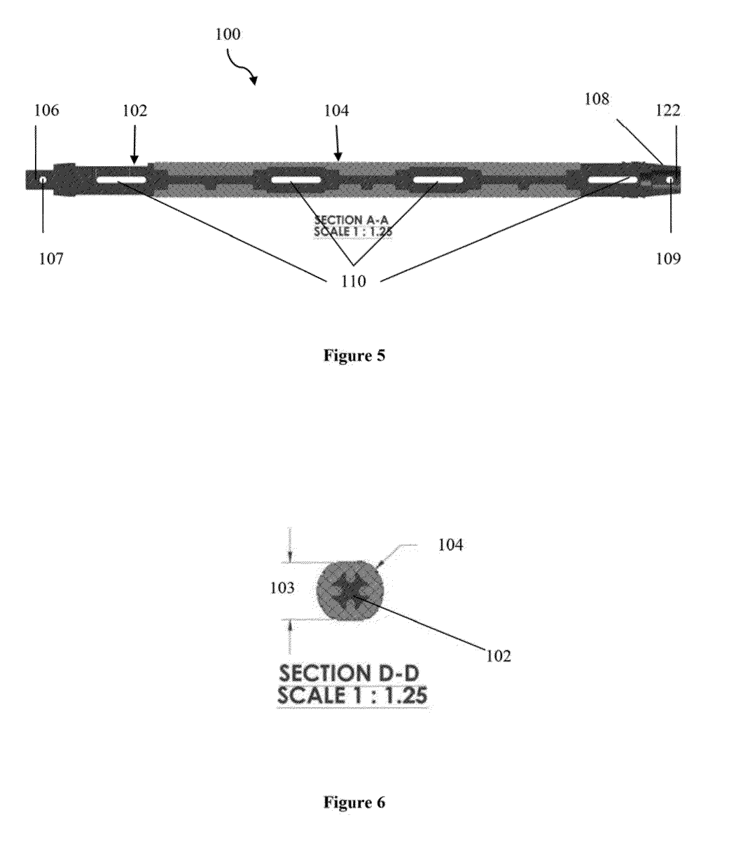

Connector 106 is located on end portion 114 and comprises a protrusion. Connector 108 is located on end portion 116 and comprises a cavity 122 (see FIG. 5). The protrusion is sized and dimensioned to fit inside cavity 122. In particular, the protrusion has a double D cross sectional shape (see FIG. 21) comprising two opposing rounded sides and two opposing flat sides. Cavity 122 has a similar cross sectional shape. This shape allows the protrusion to fit into cavity 122 in two different orientations that are 180 degrees apart, which allows non-symmetrical tool attachments (e.g., handle attachment 300) to be coupled with bar 100 in a left-handed and right-handed configuration.

The top view of FIG. 2 also shows recess 120. Recess 120 is a flat surface that has two holes, which can be used to attach other devices to bar 120, such as a flashlight or camera.

FIG. 3 is a bottom view of the bar of FIG. 1 and shows recess 112. Recess 113 is a flat surface that can be used to attach a sharpening stone or some other tool. In some embodiments, sharpening stones of different grades (coarse, medium, fine) can be removably coupled with recess 112 via hook and loop fasteners.

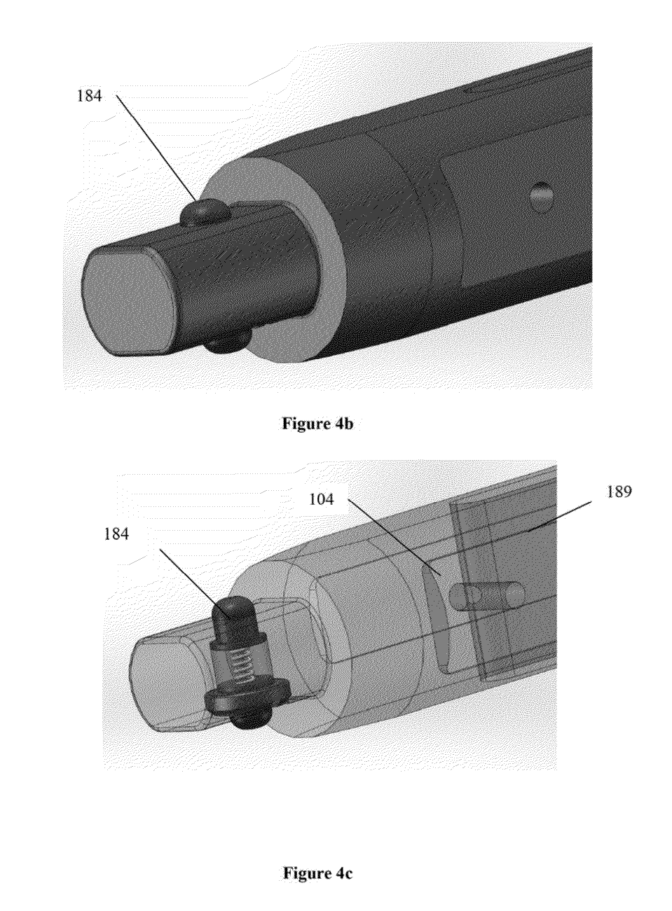

FIG. 4a is a left side view of the bar of FIG. 1, the right side view being a mirror image. The plurality of through holes 110 is clearly shown in this view. Holes 110 help to reduce the weight of bar 100. Holes 110 can also be used as attachment points to fasten straps or other devices to bar 100. In some applications, a rigid member (e.g., ladder rung) can be placed in the holes 110 of two parallel utility bars 110 to form a ladder.

FIG. 4b is a close-up perspective view of the end the bar of FIG. 1, with a double detent spring mechanism 184. A spring biases the opposing ball detents, which allows connector 106 to snap into the through hole 109 of female connector 108. The double detents lock the male and female connectors together in a quick and easy manner. Male connector 106 can be released (detached) from female connector 108 by pressing/pushing the detents (e.g., the double buttons) in (e.g., compressing the spring). The ball detents are sized and dimensioned to fit into either opening of through hole 109 (i.e., either side of bar 100) such that male connector 106 mate with connector 108 in two different configurations (e.g., left-hand and right-hand configurations, separated by a 180 degree rotation). In FIG. 4c the end 114 of bar 100 is transparent, which best illustrates the double-detent spring mechanism 184. In some embodiments, the double detent spring mechanism 184 is made of stainless steel and the spring is sized and dimensioned to provide a high-strength mechanical connection.

FIG. 4c also shows a picatinny rail attachment 189 attached to recess 120.

FIG. 5 is a cross section view taken along line A-A of FIG. 2 and illustrates how overmold 104 mechanically locks into the recessed 124 (see FIG. 17) on elongated member 102. FIG. 5 also shows the dimensions of cavity 122. Cavity 122 has a depth that is parallel to the longitudinal axis of bar 100.

FIG. 6 is a cross section view taken along line D-D of FIG. 2. FIG. 6 shows how location D-D on bar 100 has a cross sectional shape of a cross. This view also shows how bar 100 (with overmold 104) has a double D cross sectional shape.

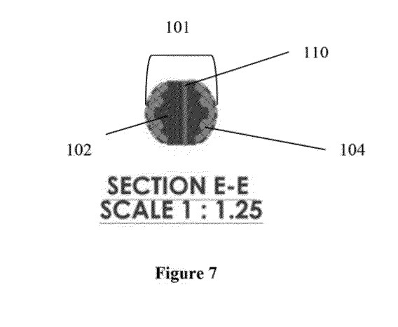

FIG. 7 is a cross section view taken along line E-E of FIG. 2. This view illustrates how the through holes 110 extend through the entire diameter of bar 100. It also illustrates the cross sectional shape of elongated member 102 at located E-E, showing the recesses 124.

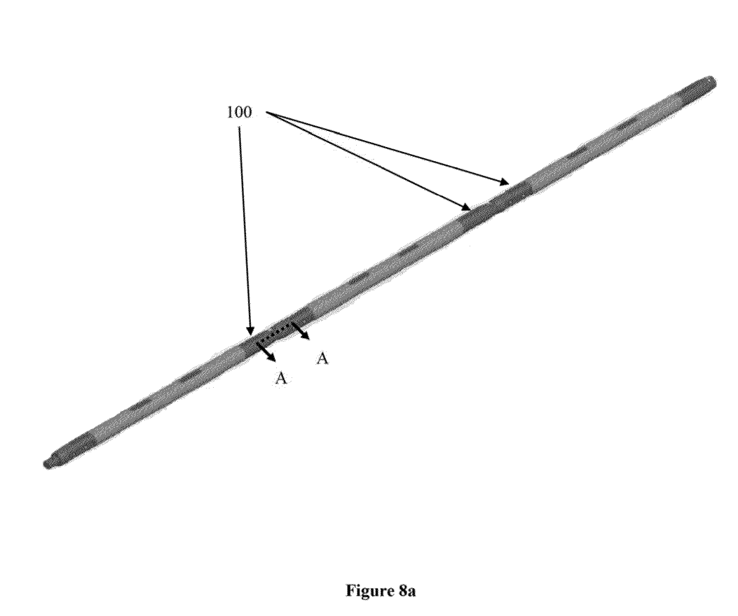

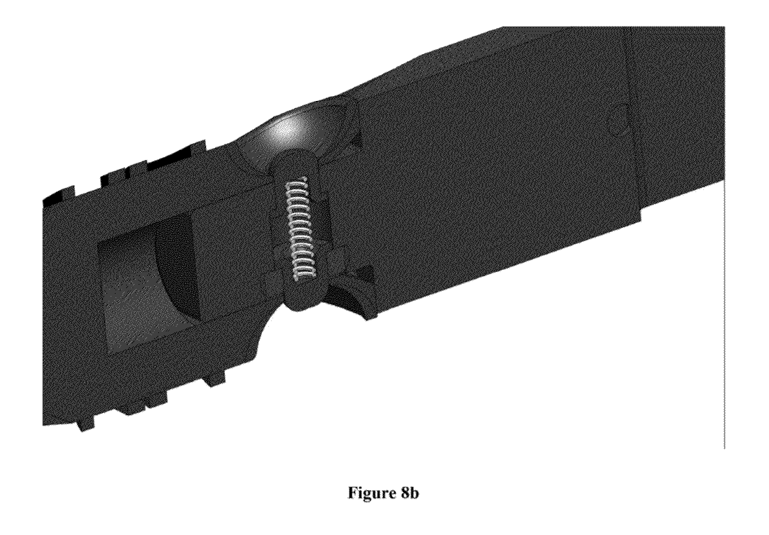

FIG. 8a is a perspective view of multiple utility bars connected in series. Since bar 100 has a male connector on one end and a female connector on another end, multiple bars 100 can be connected in series. This provides greater leverage and additional uses of bar 100.

FIG. 8b is a close up, cross sectional view taken along line A-A in FIG. 8a, showing mechanism 184 coupling two utility bars 100a and 100b.

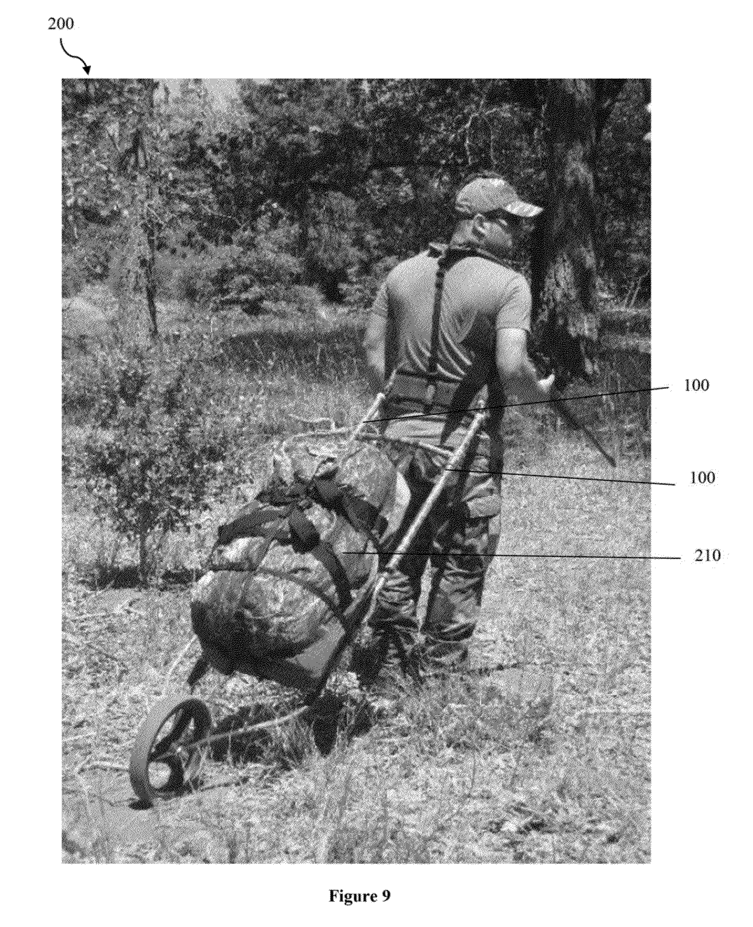

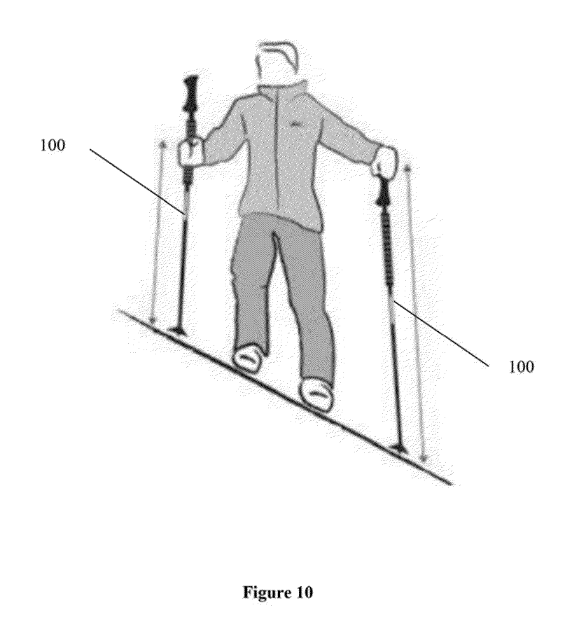

FIG. 9 shows one embodiment of a carrying apparatus 200, which utilizes a plurality of bars (e.g., bar 100a, 100b, etc) to carry a load 210.

FIG. 10 shows one application for a plurality of utility bars (e.g., bar 100a, 100b, etc.).

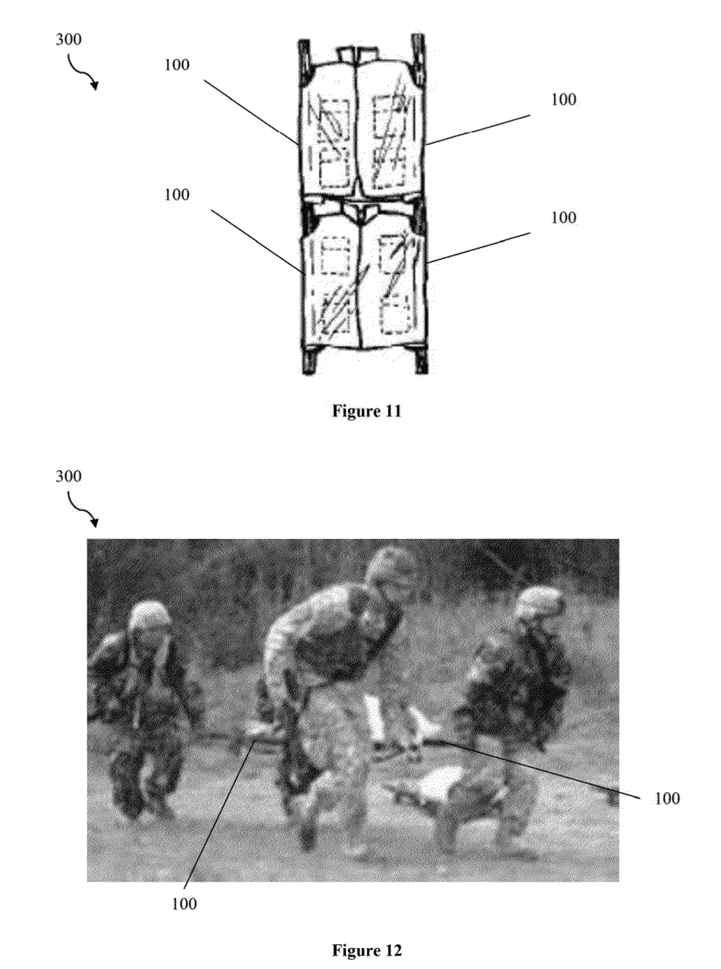

FIG. 11 shows a gurney 300, which utilizes a plurality of utility bars (e.g., bar 100a, 100b, etc.).

FIG. 12 shows gurney 300 being used by military personnel.

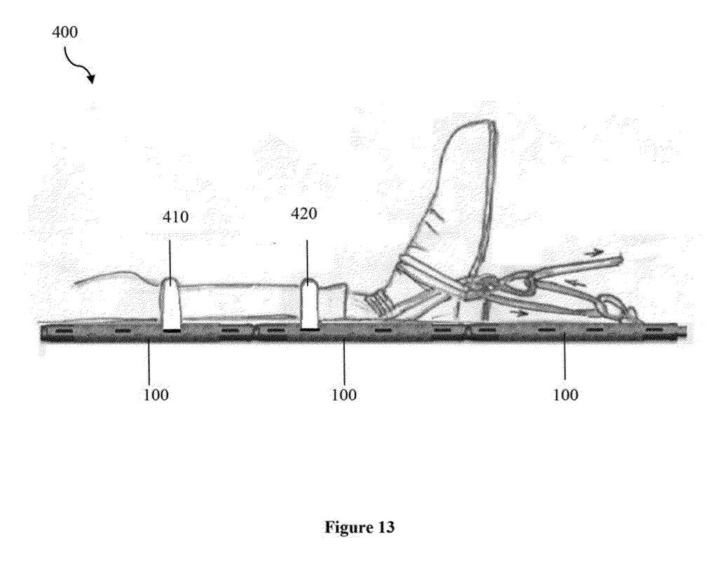

FIG. 13 shows a stint 400, which utilizes a plurality of utility bars (e.g., bar 100a, 100b, etc.). Straps 410 and 420 are wrapped around an injured person's leg and through the through holes on the utility bars.

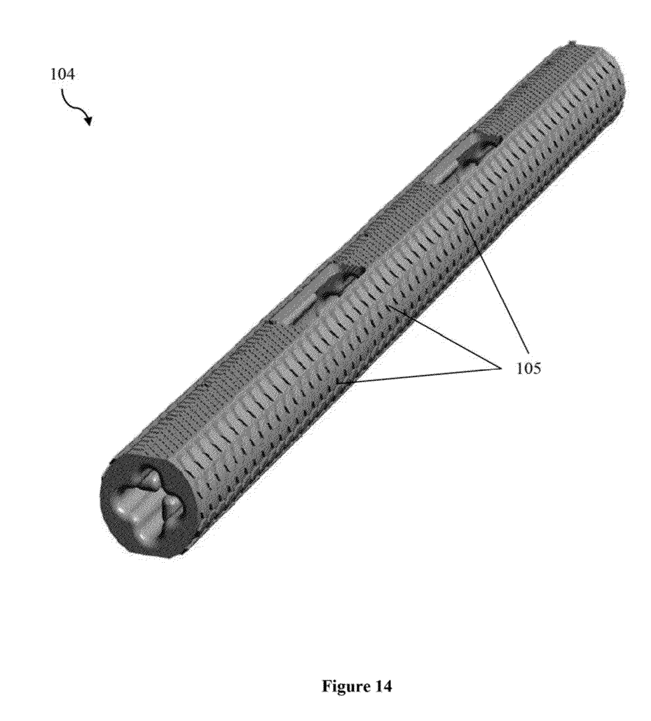

FIG. 14 is a perspective view of overmold 104 separated from elongated member 102. Overmold 104 can be made of a softer material than member 102 to provide comfortable gripping and shock absorption. In some embodiments, overmold 104 is made of a reinforced thermoplastic pipe (RTP) material, such as thermoplastic Polyolefin Elastomer (TEO), RTP 2800 B-55A FR. Overmold 104 is preferably flame retardant and rated up to 180 F or more and down to −30 F or lower. Overmold 104 can also be resistant to chemicals such as gun solvents. In other aspects of some embodiments, overmold 104 can be made of a glowing material that charges in the sun and glows for up to 8 hours or more at night. Overmold 104 also has a plurality of frictional elements 105 for improving grip.

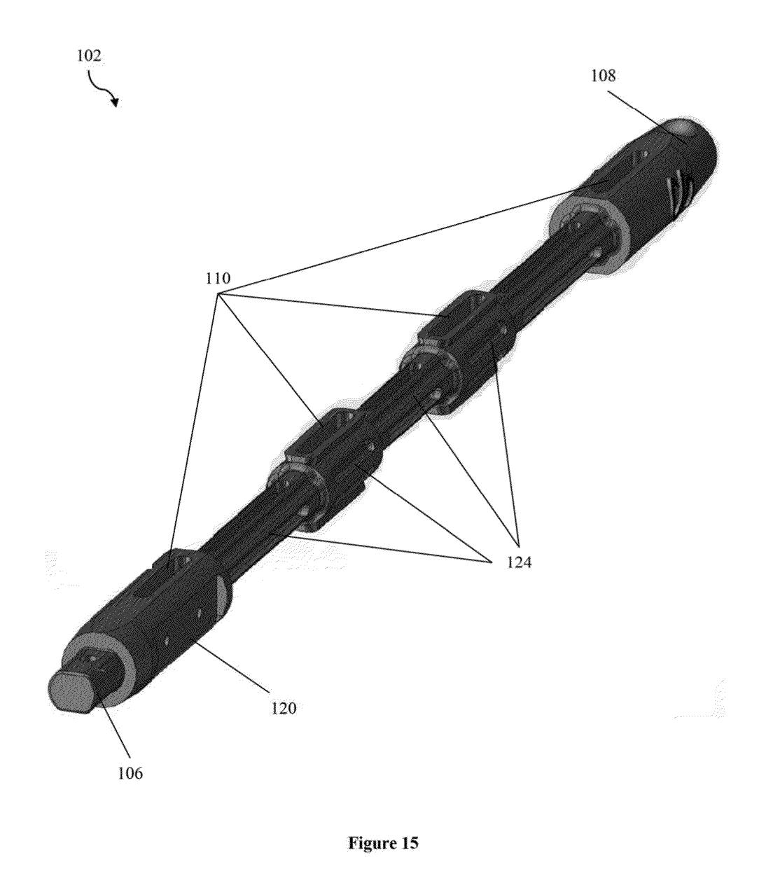

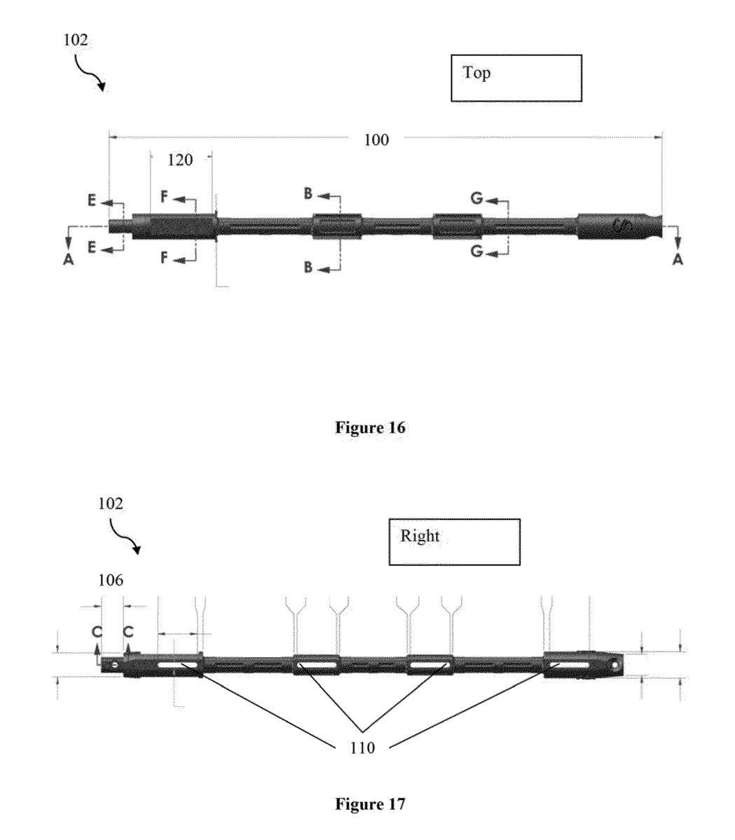

FIG. 15 is a perspective view of elongated structural member 102 separated from overmold 104. Member 102 has a plurality of recesses 124 that help to provide mechanical engagement with overmold 104. The plurality of recesses 124 include longer recesses (see FIG. 16) and shorter recess (see FIG. 17) alternating around the sides of elongated member 102.

In addition to providing mechanical engagement with overmold 104, recesses 124 also help to reduce the weight of bar 100.

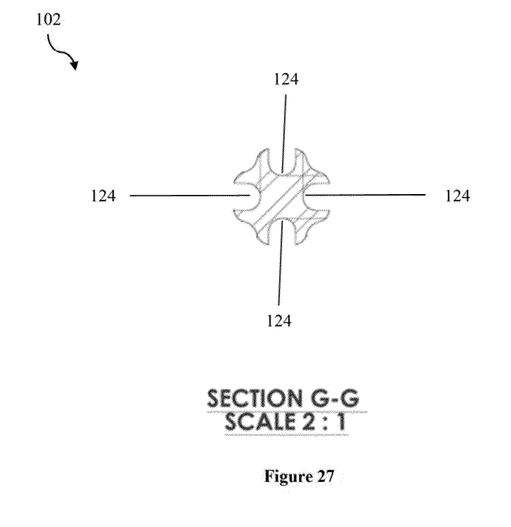

Various portions of middle section 118 of elongated member 104 have a smaller diameter than the overall diameter of bar 100. These smaller-diameter sections have a cross sectional shape of a cross, as best seen in FIG. 27.

FIG. 16 is a top view of elongated structural member 102.

FIG. 17 is a right side view of elongated structural member 102, and illustrates through holes 110.

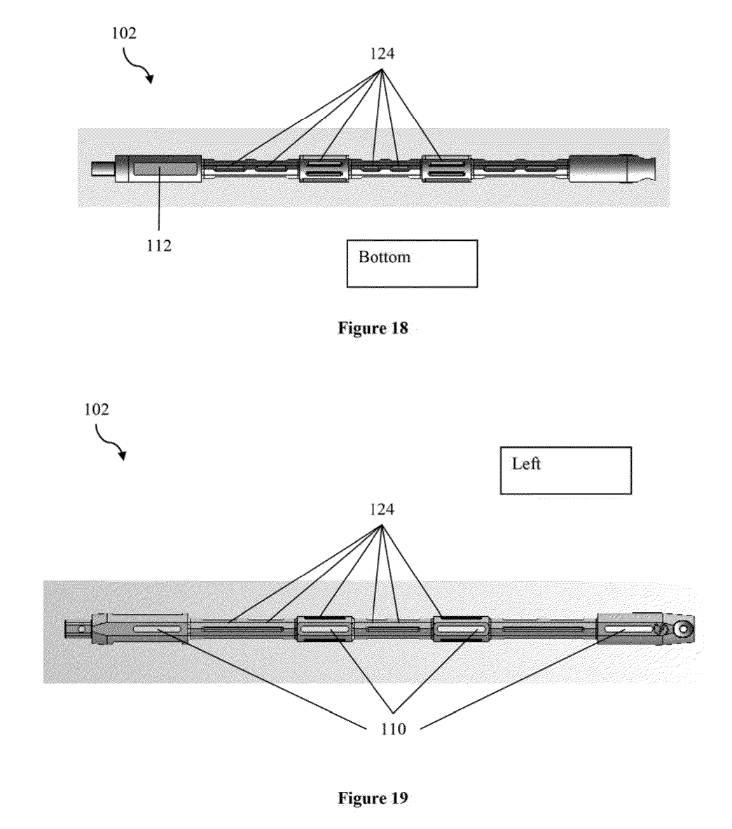

FIG. 18 is a bottom view of elongated structural member 102.

FIG. 19 is a left side view of elongated structural member 102.

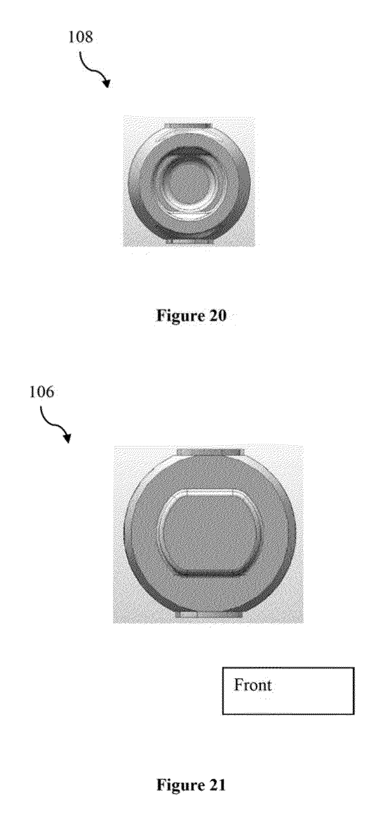

FIG. 20 is a back view of elongated structural member 102, showing cavity 122 of universal connector 108.

FIG. 21 is a front view of elongated structural member 102, showing universal connector 106.

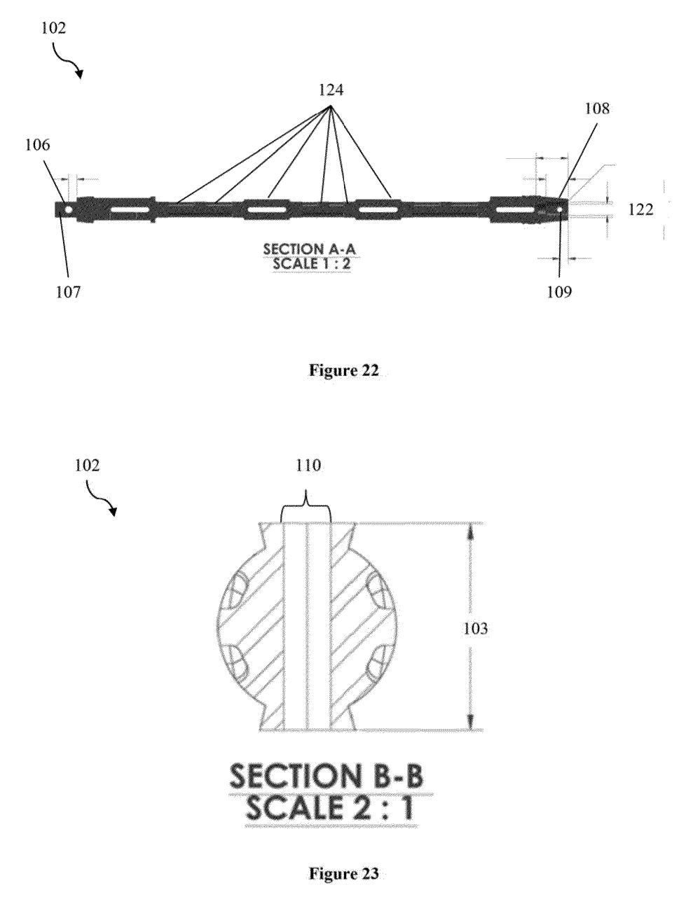

FIG. 22 is a cross section view taken along line A-A of FIG. 16. This cross section view shows the dimensions of cavity 122. This view also shows how the plurality of recesses 124 includes longer recesses and shorter recesses on different sides of member 102.

FIG. 23 is a cross section view taken along line B-B of FIG. 16, and shows the profile of through holes 110.

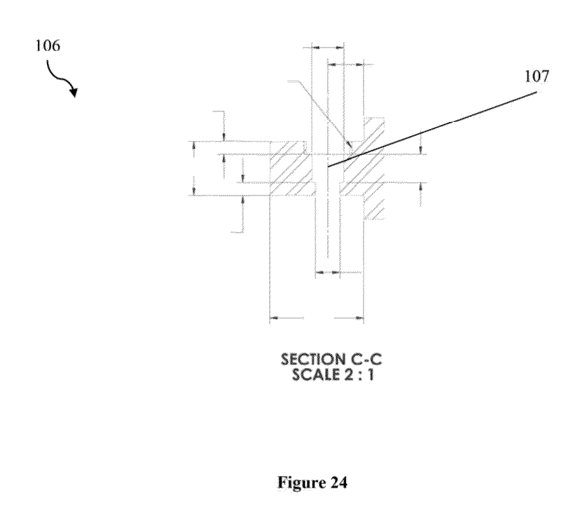

FIG. 24 is a cross section view taken along line C-C of FIG. 17, and shows the profile of through hole 107.

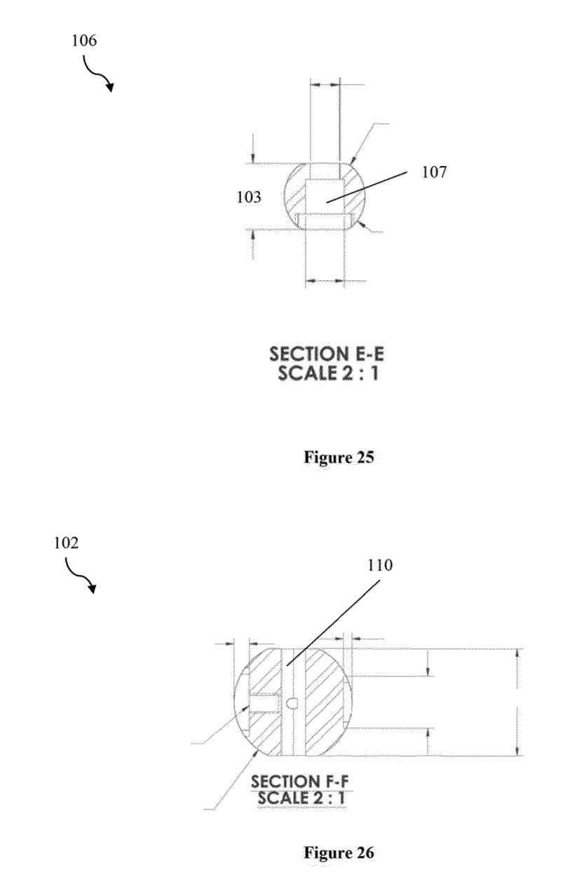

FIG. 25 is a cross section view taken along line E-E of FIG. 16, and shows the profile of through hole 107 from another perspective.

FIG. 26 is a cross section view taken along line F-F of FIG. 16. This cross section view shows recesses 112 and 120, in addition to through hole 110.

FIG. 27 is a cross section view taken along line G-G of FIG. 16, and shows how middle section 118 has a cross-shaped cross section at this location, with recesses 124 at all four ends of the cross. At other locations along middle section 118, the cross only has two recesses (on two adjacent ends of the across).

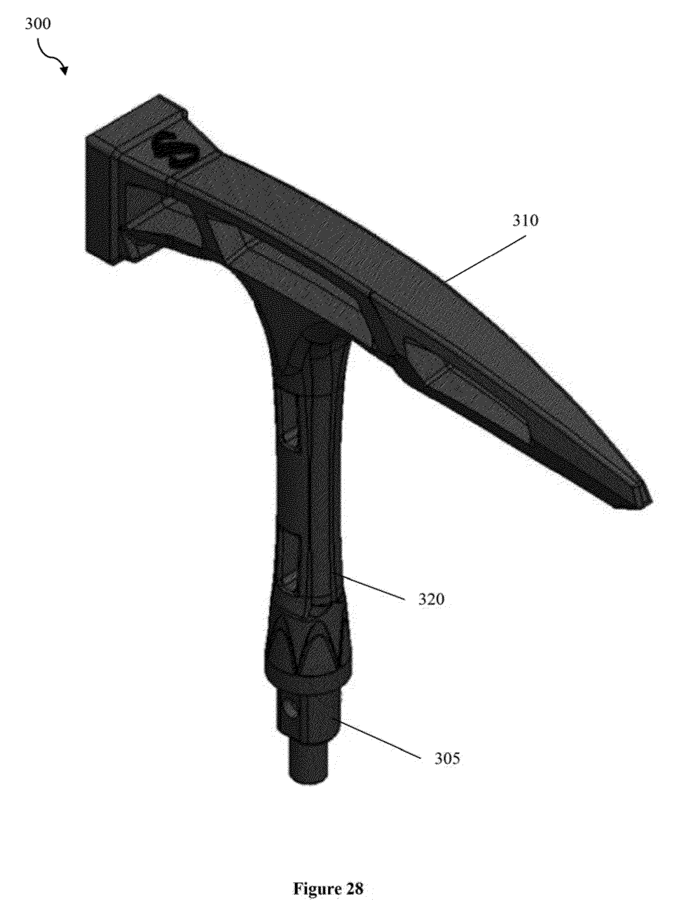

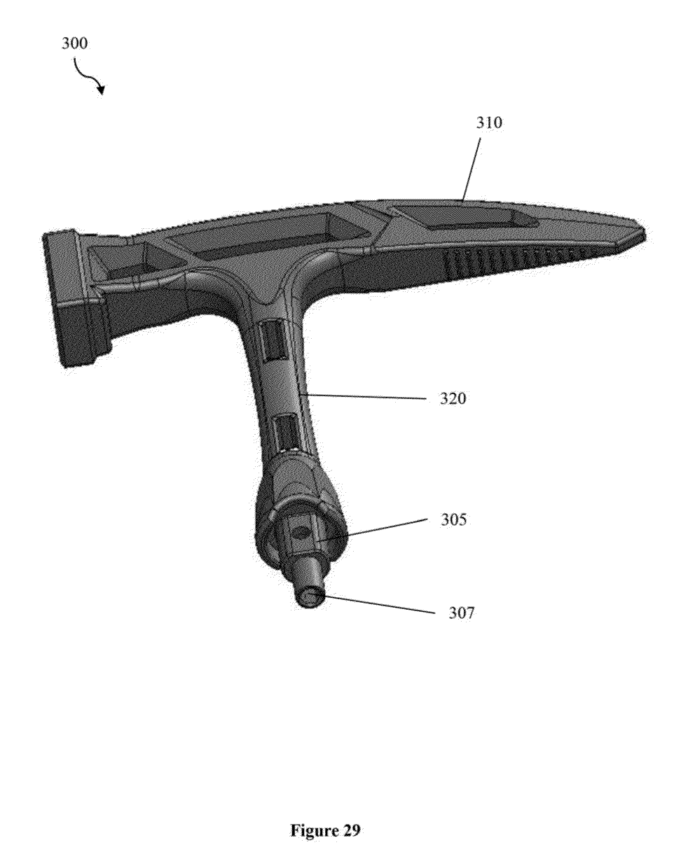

FIG. 28 is a top perspective view of handle attachment 300. Handle 300 is t-shaped and has a handle portion 310 and stem portion 320 that extends perpendicular to the handle portion 310. In other embodiments, stem portion 320 could extend at an angle (other than 90 degrees) from handle portion 310. FIG. 29 is a bottom perspective view of handle 300 and illustrates the features of universal connector 305 on stem portion 320. Universal connector 305 is similar to connector 106 except that it also has a hex nut socket 307.

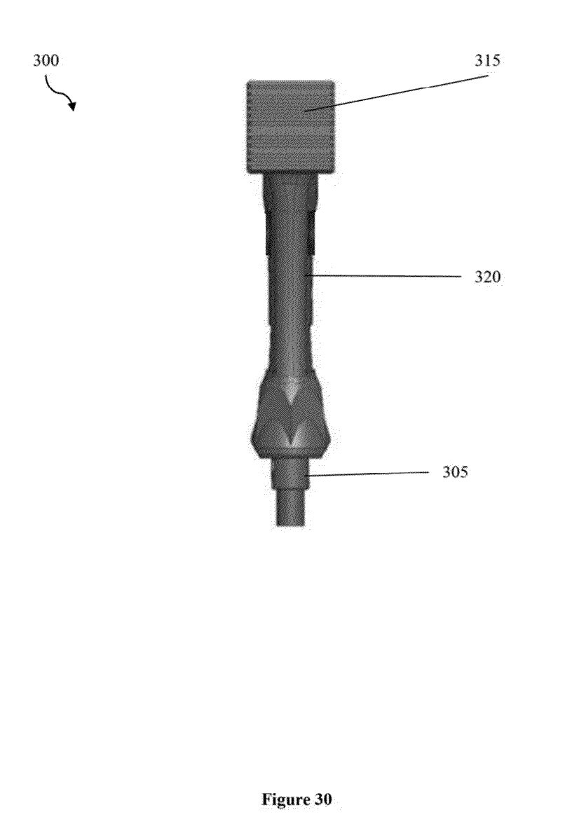

FIG. 30 is a front view of handle 300.

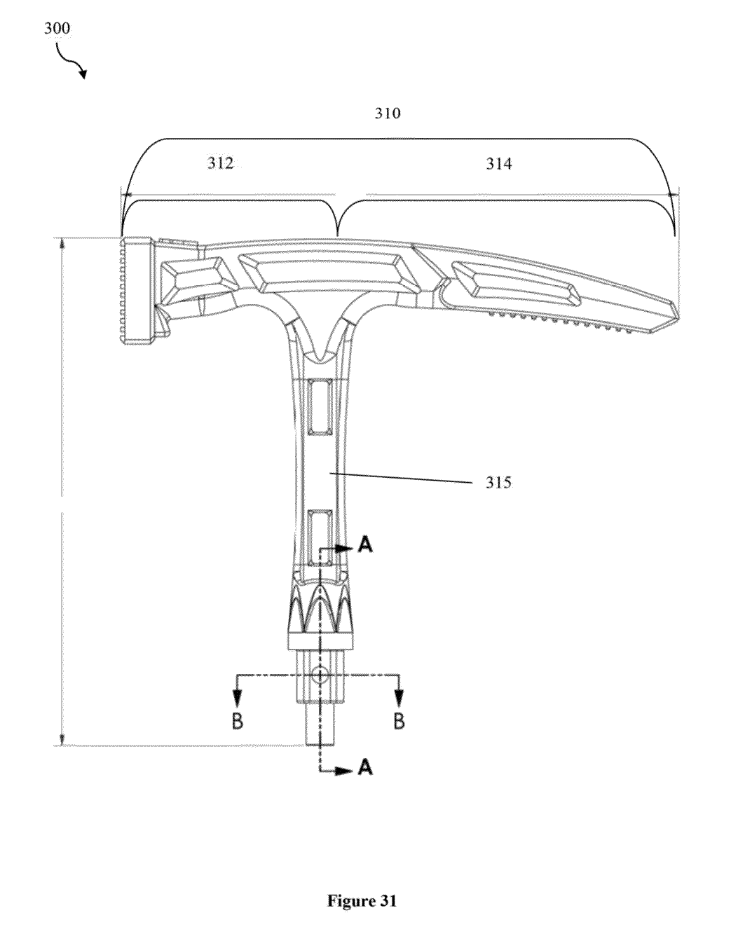

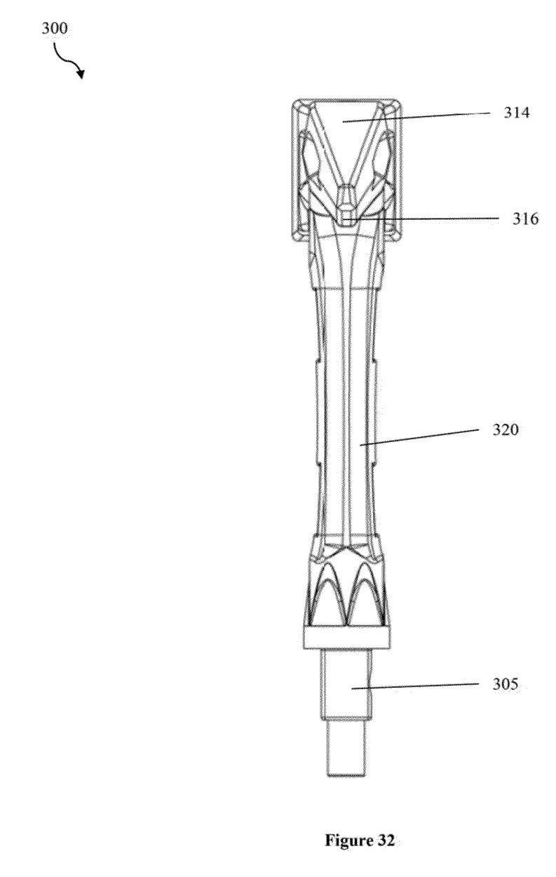

FIG. 31 is a right side view of handle 300. Handle portion 310 has a blunt end 312 and a pointed end 314. Blunt end 212 has a blunt surface 315 with a plurality of teeth. Handle portion 310 also has three through holes that help to reduce weight and serve as attachment points. Stem portion 320 also has two recesses that reduce weight and serve as attachment points. Handle portion 310 is curved slightly downward to provide an ergonomic grip when used as a handle. In addition, handle portion 310 meets stem portion 320 at two rounded surfaces—one on underside of blunt end 312 and the other on the underside of pointed end 314—which also provide a comfortable ergonomic grip.

The underside of blunt end 312 also has a sharp edge 391, which can be used as a spanner wrench. The underside of pointed end 314 has a plurality of teeth for repelling, rock climbing, and gripping. Stem portion 320 has through holes 318, which can be used as attachment points. Holes 318 can also be used as a tie down for a tourniquet.

FIG. 32 is a back view of handle 300. Pointed end 314 forms a point 316 for picking and prying.

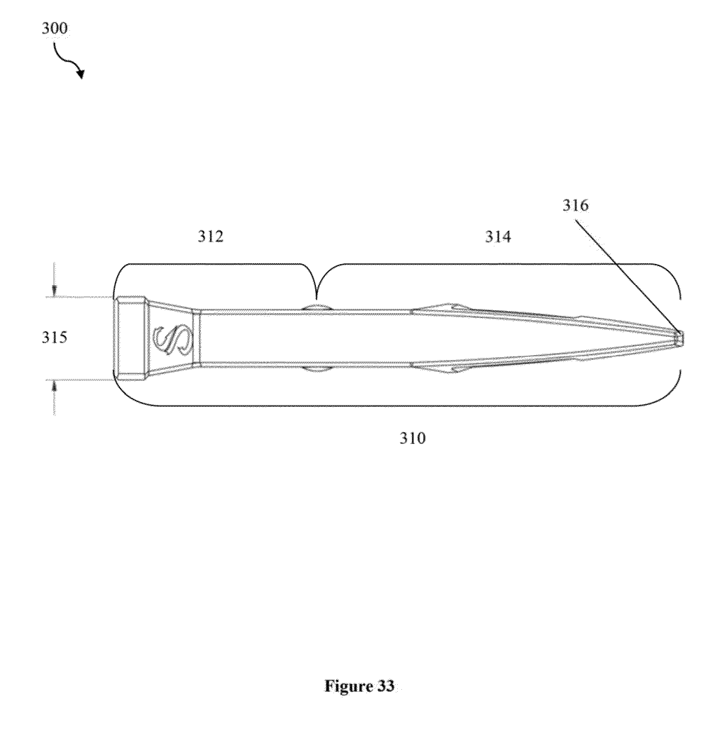

FIG. 33 is a top view of handle 300.

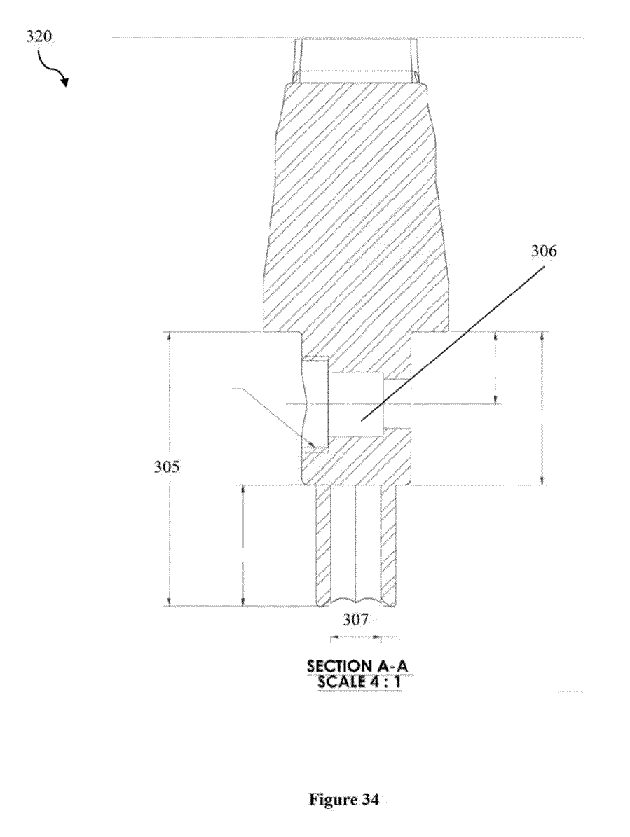

FIG. 34 is a cross section view taken along line A-A of FIG. 31. This view shows through hole 306 of universal connector 305. This view also shows socket 307.

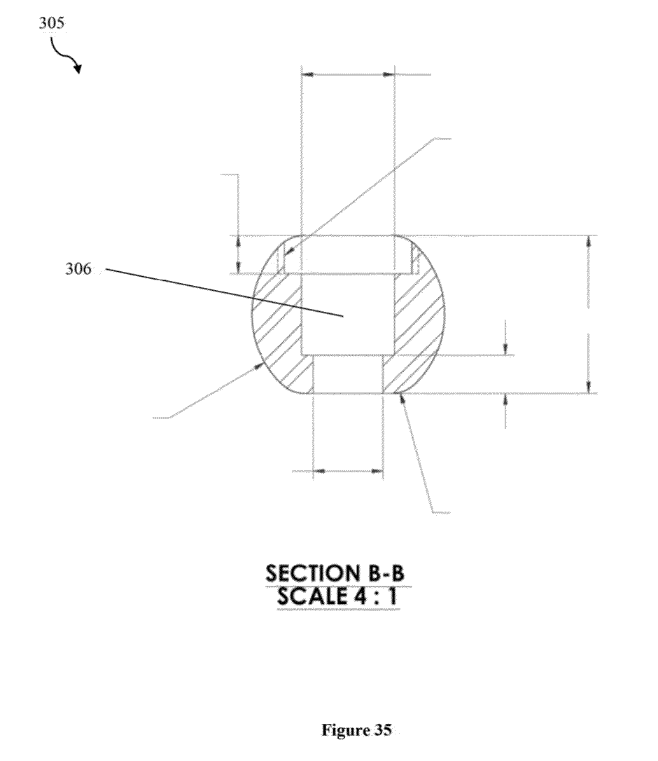

FIG. 35 is a cross section view taken along line B-B of FIG. 31. This view shows another perspective if through hole 306. Through hole 306 can have a double detent spring mechanism placed therein for snap fitting into a female connector, as discussed above.

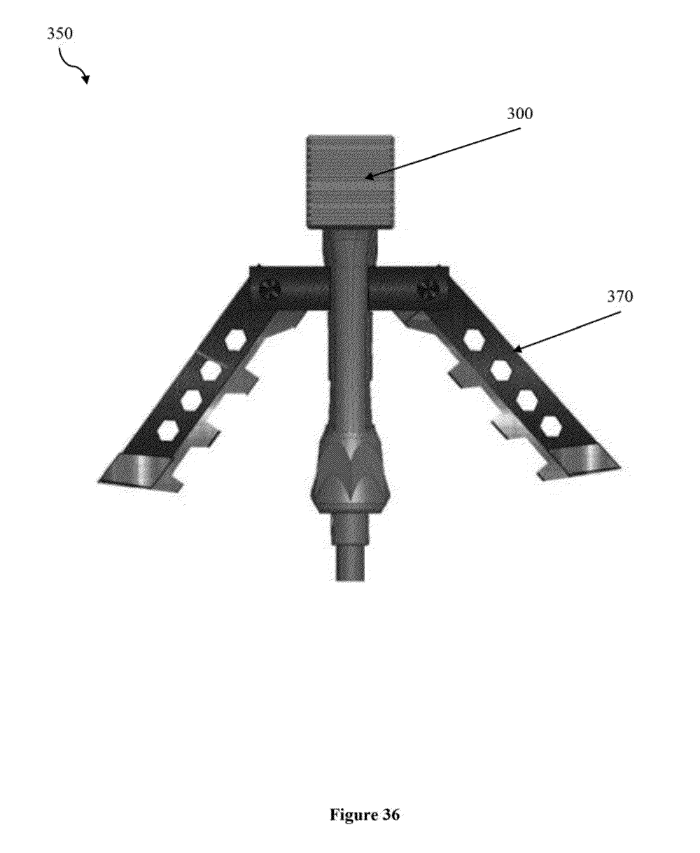

FIG. 36 is a front view of handle 300 in combination with a grapple attachment 370. Together, handle 300 and grapple attachment 370 can be used as a grappling hook. Grapple attachment 370 has two angled wings, each with a plurality of inward facing protrusions.

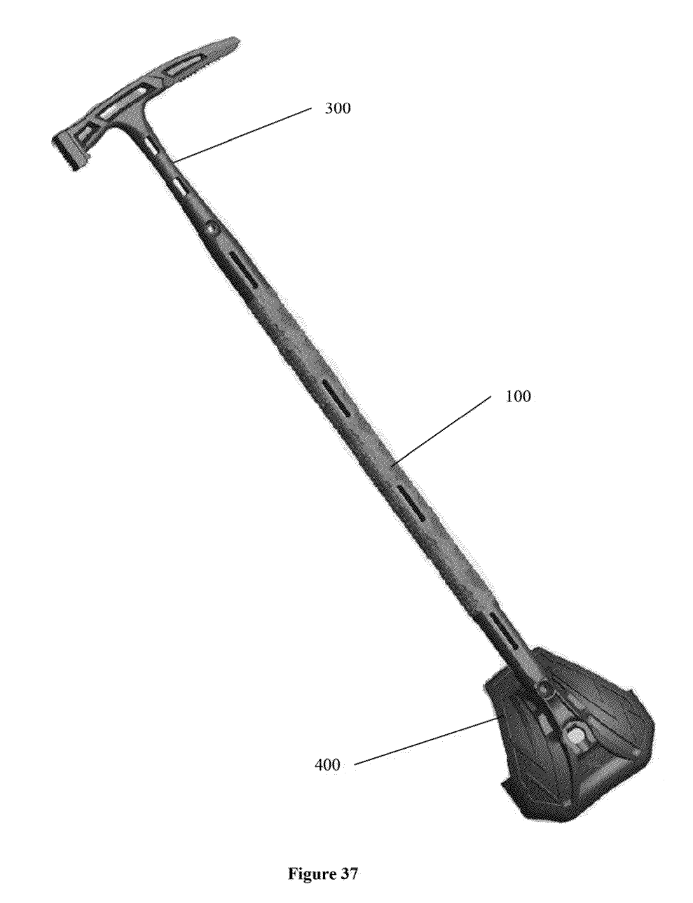

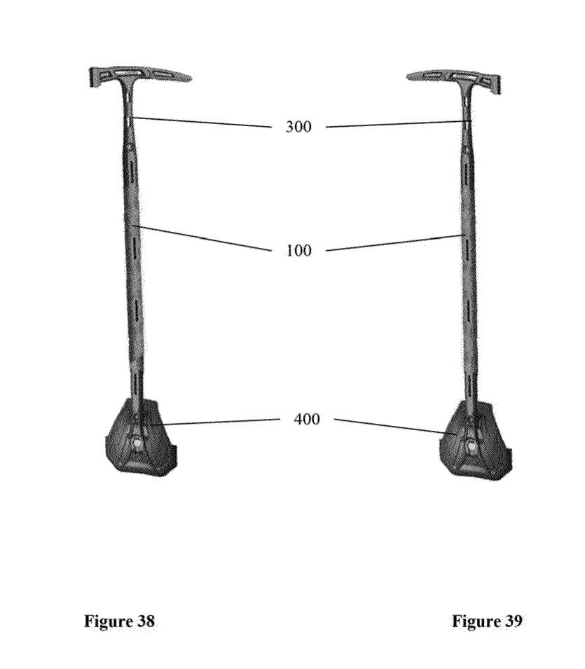

FIGS. 37 and 38 show how handle 300 can attach to bar 100 in a left-handled orientation (FIG. 37) and right handed orientation (FIG. 38).

FIG. 39 is a perspective view of the tool of FIG. 37, wherein the handle is attached to the utility bar in a left-handed configuration.

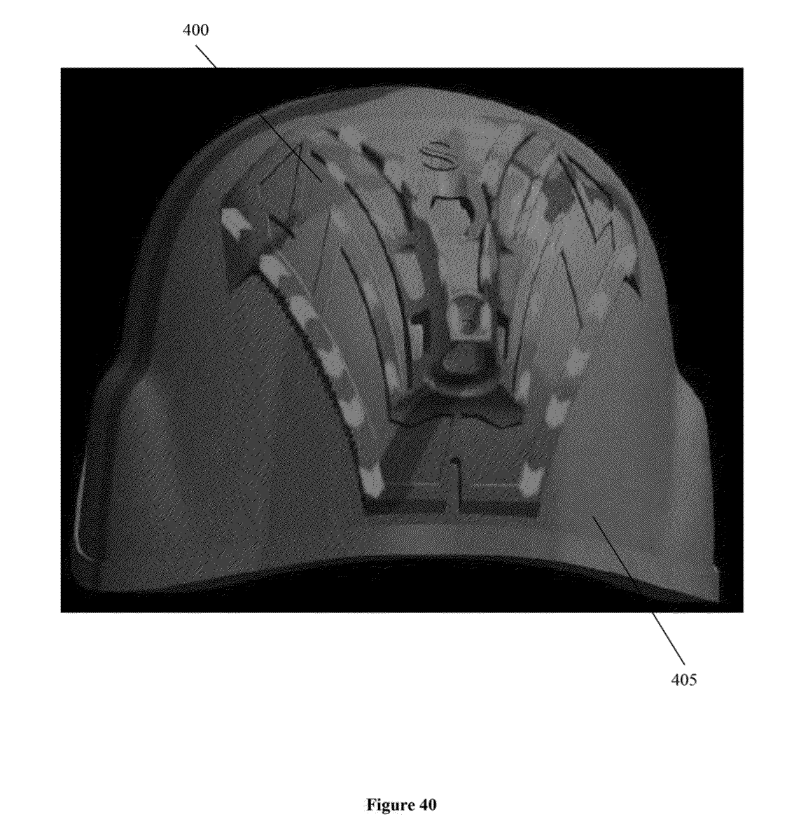

FIG. 40 is a back, perspective view of a helmet 405 with shovel head counterweight 400 attached to the helmet.

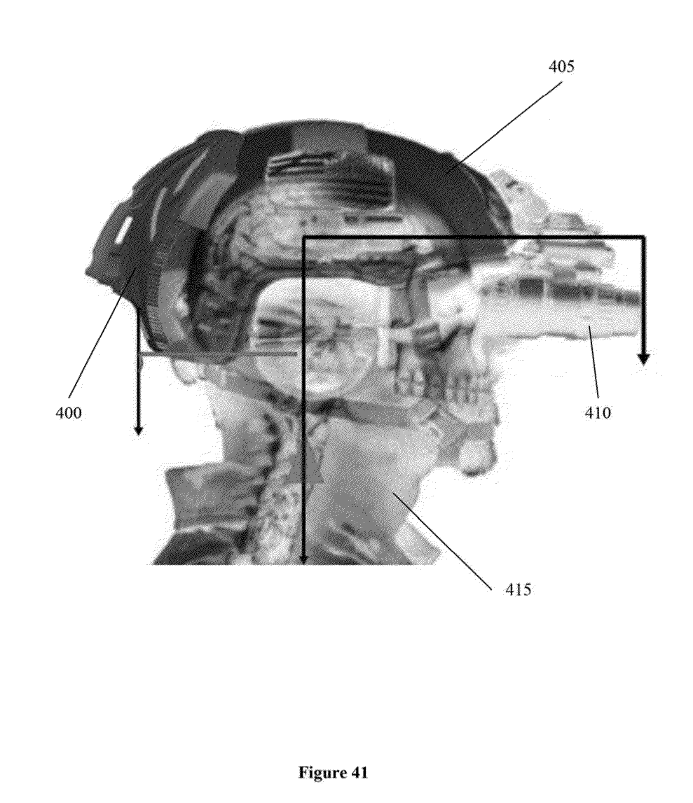

FIG. 41 is a side view of a person 415 wearing helmet 405. Counterweight 400 counterbalances the weight of night vision goggle unit 410 relative to the person's neck.

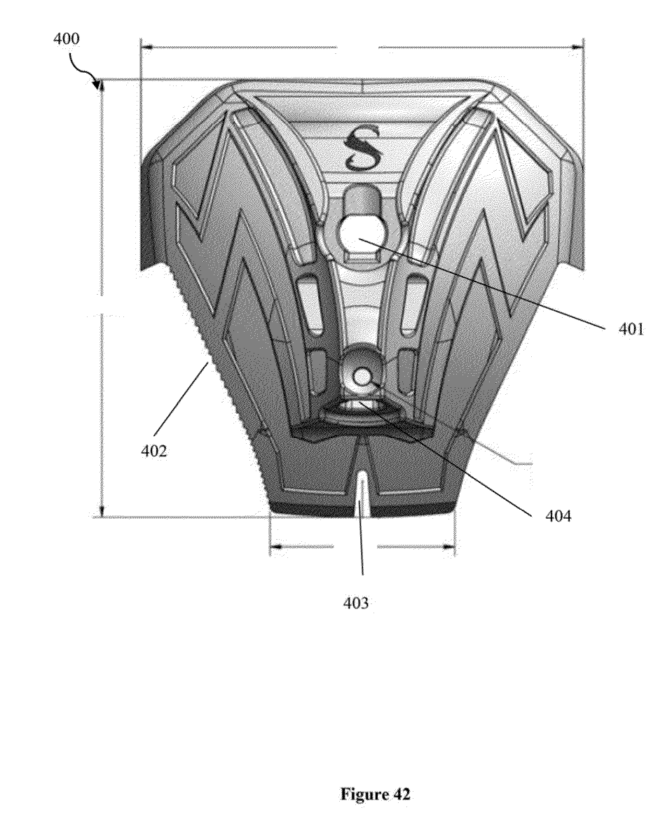

FIG. 42 is a top view of counterweight 400. Counterweight 400 has two universal connectors 401, 404 for attaching bar 100. Counterweight 400 also has a corrugated edge 402 and a notch 403, which provide additional functionality.

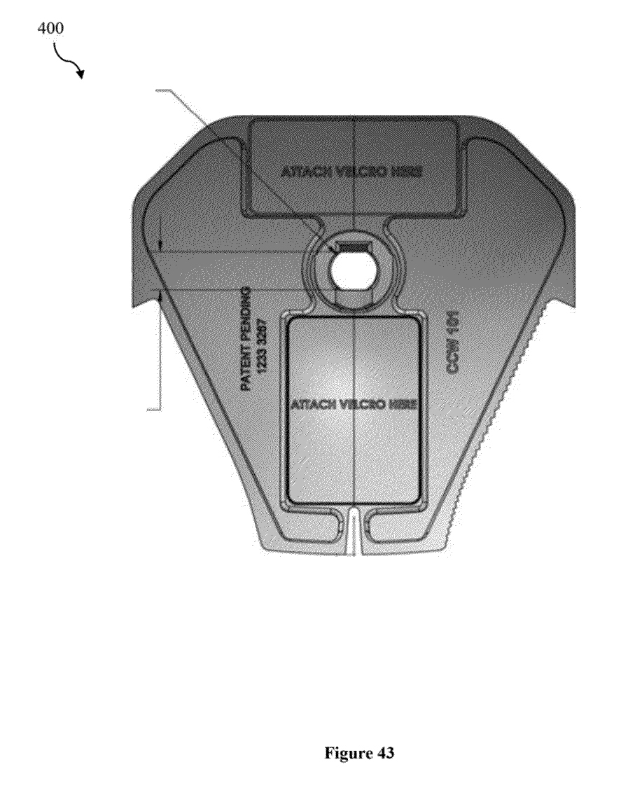

FIG. 43 is a bottom view of counterweight 400. Hook and loop fasteners can be attached to this surface so that counterweight 400 can be removably and repositionably attached to helmet 405.

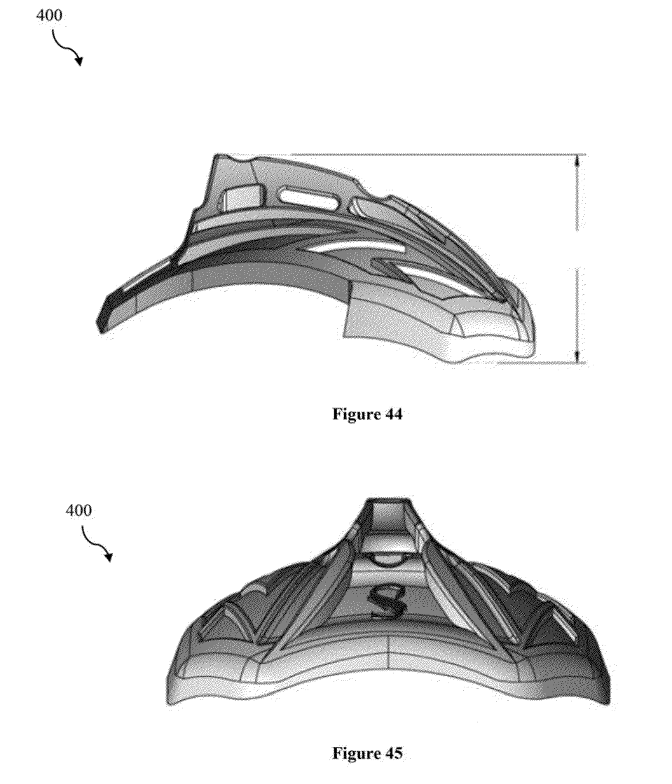

FIG. 44 is a left side view of counterweight 400.

FIG. 45 is a front view of counterweight 400.

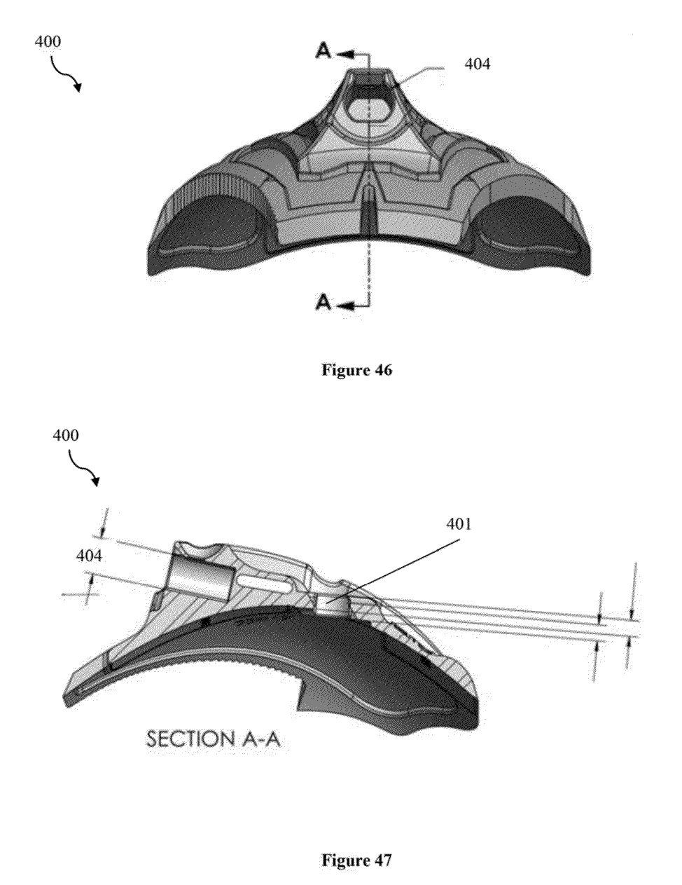

FIG. 46 is a back view of the counterweight of FIG. 40.

FIG. 47 is a cross section view taken along line A-A of FIG. 46, showing universal connector 404 and 401.

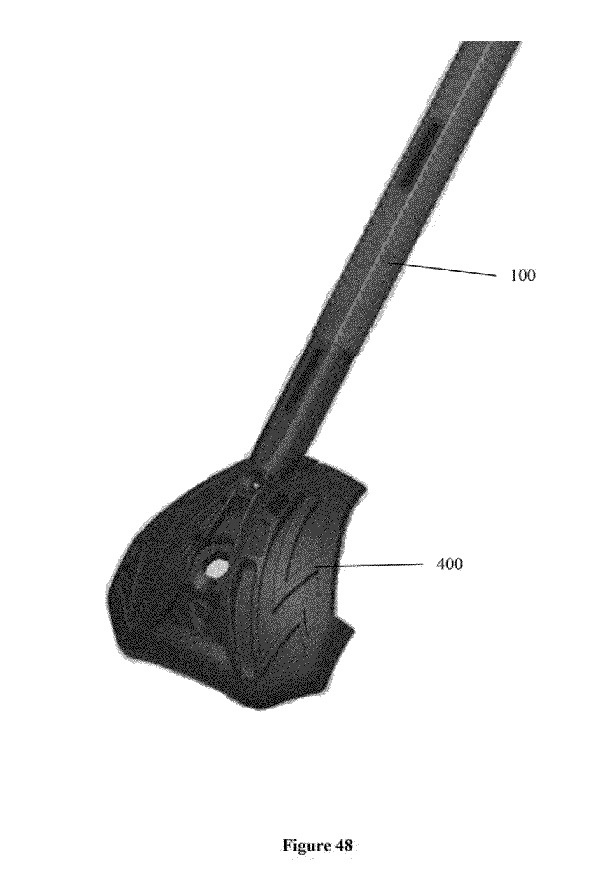

FIG. 48 is a close-up perspective view of counterweight 400 attached to utility bar 100 in a digging configuration.

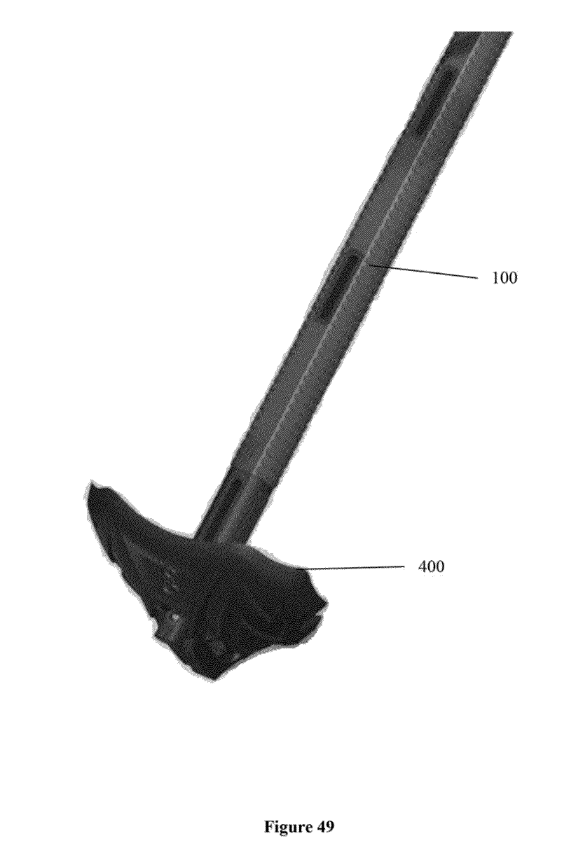

FIG. 49 is a close-up perspective view of counterweight 400 attached to utility bar 100 in a scooping configuration.

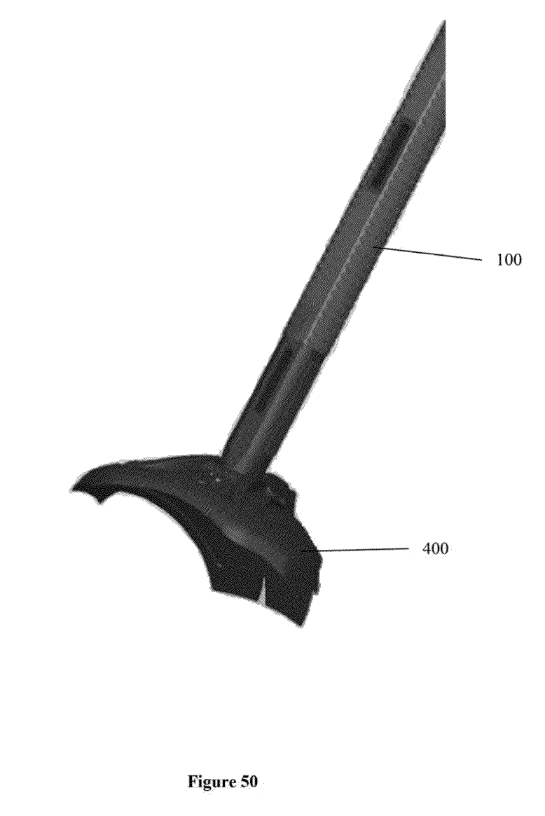

FIG. 50 is a close-up perspective view of counterweight 400 attached to utility bar 100 in a standing monopod configuration.

Shovel head counterweights are described in further detail in co-owned US International Patent Application Serial no. PCT/US14/44466, which is incorporated herein by reference.

In another aspect, the inventor contemplates a spear tool attachment for multi-purpose use. The spear tool attachment comprises a first end portion, an intermediate portion, and a second end portion. The first end portion typically comprises a point (i.e., a tapered, sharp end of a tool). The second end portion comprises a universal connector that is sized and dimensioned to engage a utility bar (e.g., the utility bar described above). By engaging a utility bar, it should be appreciated that a user will gain additional leverage to use the spear tool. The intermediate portion comprises a stepped opening having a plurality of steps that define a plurality of widths. It is contemplated that the plurality of widths can be used to engage several different sized hex nuts and a rectangular shut off valve. Therefore, several advantageous features are gained by the spear tool attachment.

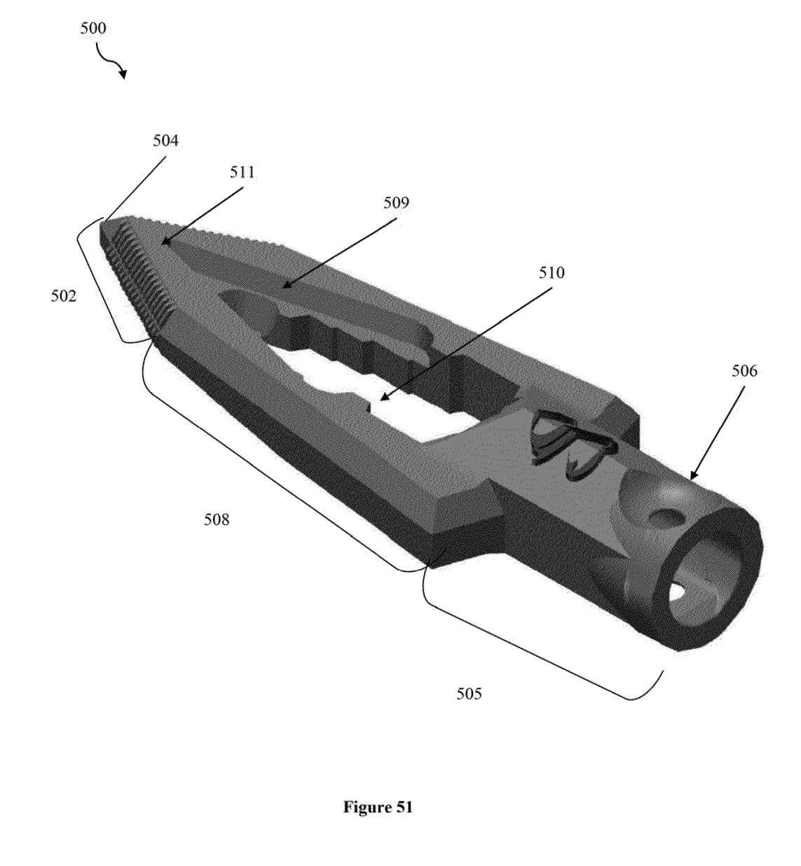

FIG. 51 shows an embodiment of a spear tool attachment 500. Spear tool attachment 500 comprises a first end portion 502 having a point 504. In addition, spear tool attachment 500 has a second end portion 505 having a universal connector 506. An intermediate portion 508 comprises a stepped opening 510 that is an opening is disposed in the middle of spear tool attachment 500. However, it should be contemplated that stepped opening 510 can be disposed another position (e.g., closer to the front, side, or back of spear tool attachment 500). Intermediate portion 508 also comprises a recessed portion 509 that forms a v-shaped recess 511 on a top surface of spear tool attachment 500 concentric with a profile of the first end portion and intermediate portion.

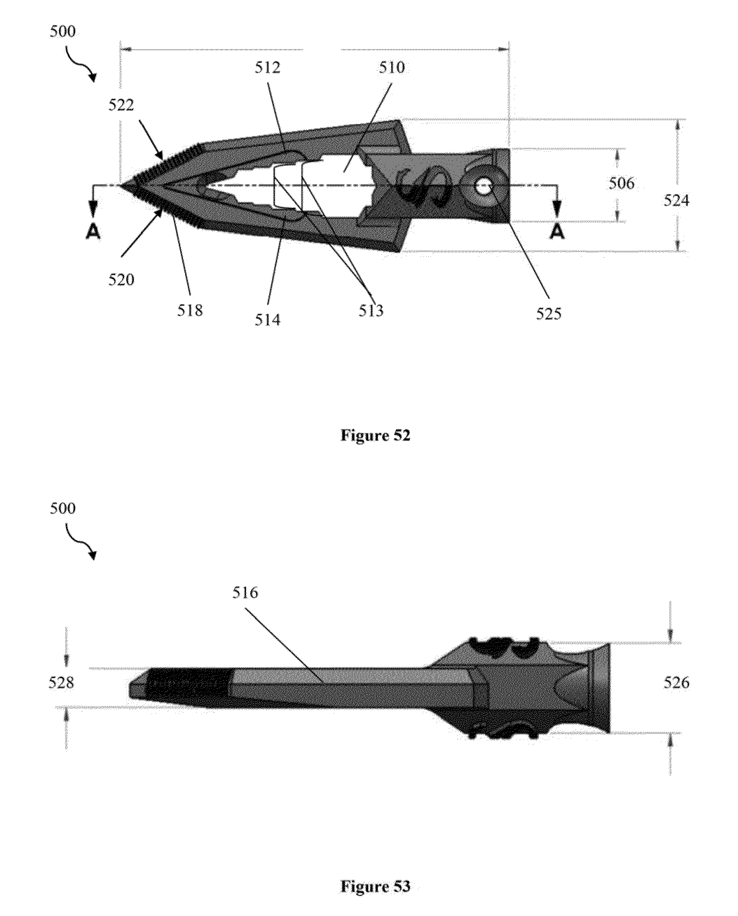

First end portion 502 can include a third side 520 and a fourth side 522 each having a plurality of teeth 518 as shown in FIG. 52. Teeth 518 can be used to provide friction for various prying and chiseling activities. Although spear tool attachment 500 has teeth are disposed on both sides of first end portion 502, it is contemplated that other spear tool attachments comprise teeth on only one side or no teeth on either side. For example, a spear tool attachment can have teeth on one side and a sharpened blade on the other side so that the teethed side of the first end portion 502 can be used for prying, and the sharpened blade side of first end portion 502 can be used for cutting.

As mentioned above, first end portion 502 typically comprises point 504. Point 504 is a tapered, sharp end of spear tool attachment 500. By providing this sharpened structure, it is contemplated that spear tool attachment 500 can be utilized with a utility bar to form an assault spear for military personnel. While spear tool attachment 500 uses point 504, it is contemplated that other structures can be utilized, such as a curved structure and a rectangular structure.

When viewed from a top view, first end portion 502 can meet intermediate portion 508 at an obtuse angle as shown by spear tool attachment 500. Indeed, unlike typical spears that simply narrow in a straight line to a point, spear tool attachment 500 gradually narrows in tool width in intermediate portion 508 and then the tool width sharply narrows in first end portion 502 to provide an angular shape. Typically, the intermediate portion width that narrows from second end portion 505 to the first end portion 502.

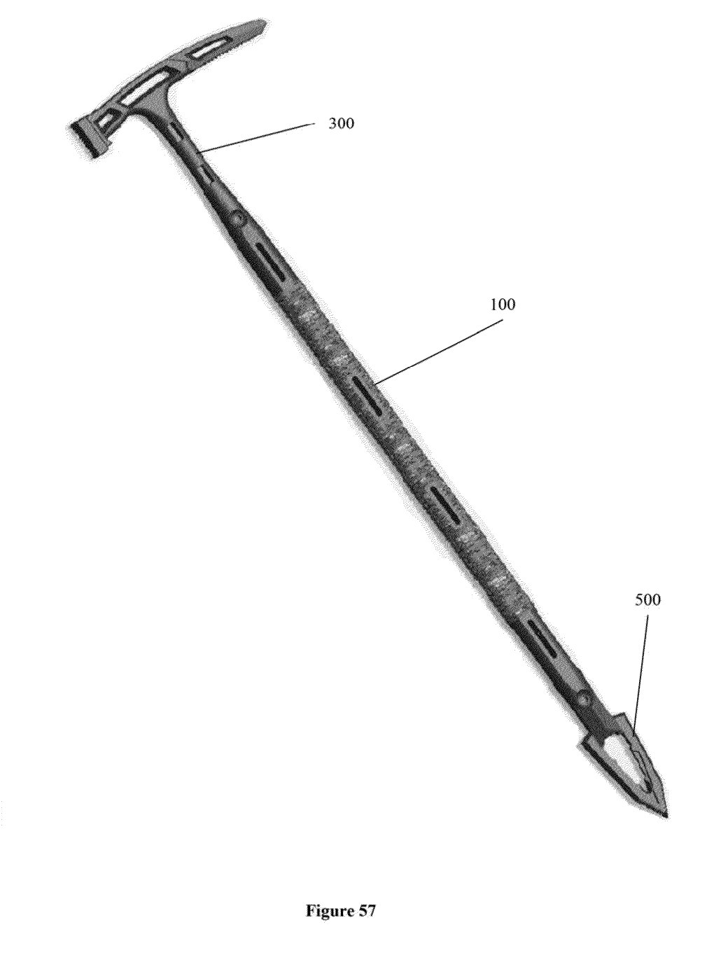

It should be appreciated that the angular shape provides a broader region in intermediate portion 508 for chopping and a narrow region in first end portion 502 for picking or chiseling. For example, spear tool attachment 500 can be used for rocking climbing to pry into a crack in a rock to create an attachment point. The plurality of teeth 518 will help to hold attachment 500 in place in the crack by providing addition friction. It is also contemplated that first end 502 and intermediate portion 508 have a sharp edge 516 as shown in FIG. 57 for various functions, such as slicing, chiseling or cutting.

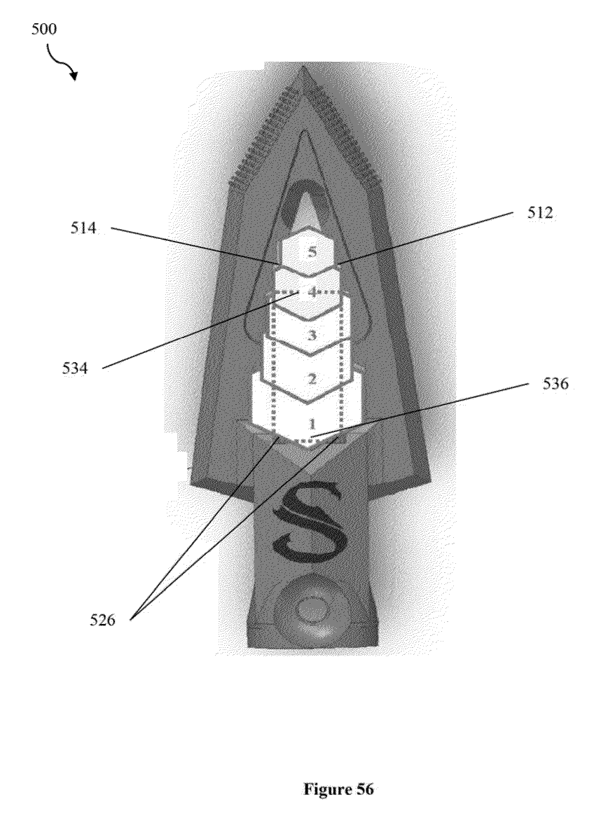

Returning to FIG. 56, intermediate portion 508 has a stepped opening 510 having a plurality of steps that define a plurality of distinct widths 513. The plurality of steps is disposed on a first side 512 and a second side 514 of stepped opening 510. Plurality of distinct widths 513 is typically defined as a dimension from first side 512 to second side 514 as shown in FIG. 56. While first side 512 and second side 514 are both shown to be stepped, it is contemplated that only one side is stepped and the other is flat or linear. Moreover, preferred embodiments include a gradual reduction in the size of the steps and/or width between the steps as shown in FIG. 56 to provide better engagement with different sized nuts (e.g., hex nuts). First side 512 and a second side 514 intersect at an acute angle near first end portion 502 to provide various functionalities, such as a nail puller and a wire cutter/stripper. It should be appreciated that other angles (e.g., right or obtuse) are contemplated.

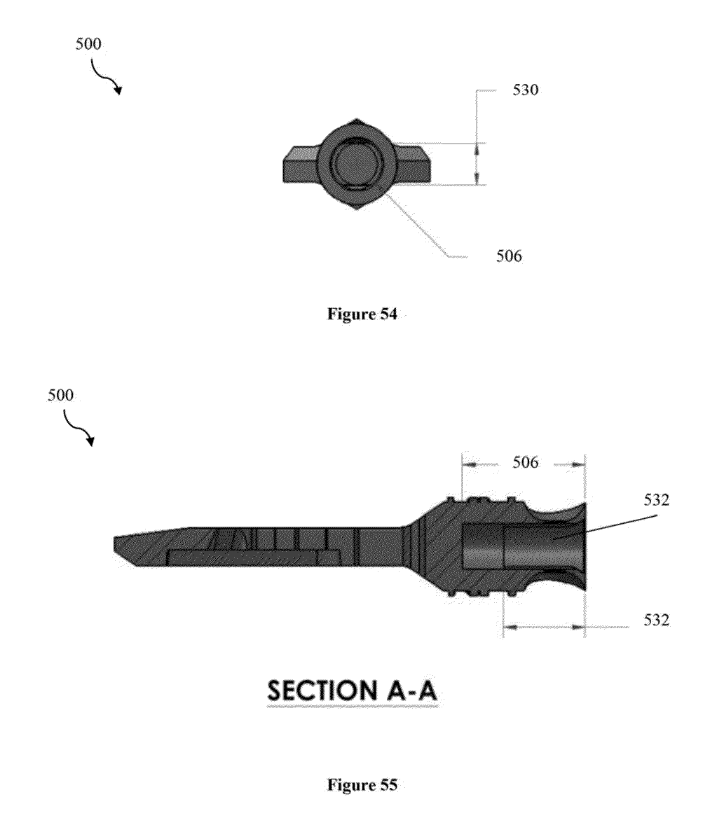

Spear tool attachment 500 also comprises second end portion 505 having a universal connector 506. Universal connector comprises a through hole 525 and a cavity 532. FIGS. 54 and 55 show a back view and a cross-sectional view of A of spear tool attachment 500. Through hole 525 can be perpendicular to cavity 532, such that the opening of cavity 532 is disposed in a horizontal direction and the opening of through hole 525 is disposed in a vertical direction. Moreover, universal connector 506 can be cylindrically-shaped. In preferred embodiments, universal connector 506 is sized and dimensioned to engage a utility bar (e.g., the utility bar described above).

FIG. 56 shows the various nuts that spear tool attachment 500 can engage. Plurality of distinct widths 513 can be sized and dimensioned to engage a ⅝ inch (hexagon 1 in FIG. 56), ½ inch (hexagon 2 in FIG. 56), 7/16 inch (hexagon 3 in FIG. 56), ⅜ inch (hexagon 4 in FIG. 56), and 5/16 inch hex nut (hexagon 5 in FIG. 56). Furthermore, the stepped opening is further sized and dimensioned to engage a rectangular-shaped shutoff value (dotted rectangular shape), such as standard oxygen tank, E/D cylinders and gas related delivery systems. It should be noted that engagement to a nut or a shutoff valve can be accomplished by contacting two sides of the nut or valve or all sides (e.g., surrounding the corners of the rectangle in FIG. 56) of the nut or valve.

As shown in FIG. 56, the plurality of steps comprises a first stepped side 512 and a second stepped side 514 that is opposite to first stepped side 512 relative to the longitudinal axis of the intermediate portion. Moreover, spear tool attachment comprises a pair of opposing right-angle notches 526 near (i.e., closer to the second end portion) second end portion 505 and separated by a first width 536. First width 536 of pair of opposing right-angle notches 526 can equal to one of the plurality of distinct widths 534 to allow engagement to a rectangular shutoff valve (dotted rectangular shape in FIG. 56).

Spear tool attachment 500 can be composed of many suitable materials so long as it is rigid and strong to provide some of the various functionalities described above. For example, the first end portion, intermediate portion, and second end portion can be made of stainless steel.

Furthermore, spear tool attachment 500 can be used as a sundial by laying tool attachment on the ground and drawing a circle around it. The contours of spear tool attachment provide a shadow that gives a user an approximation of the time.

FIG. 57 shows that spear tool attachment 500 can be used with utility bar 100 and handle 300 to provide a spear. As noted above, a universal connector can be used to couple utility bar 100 and spear tool attachment 500. In another aspect, the inventor contemplates an extractor tool attachment.

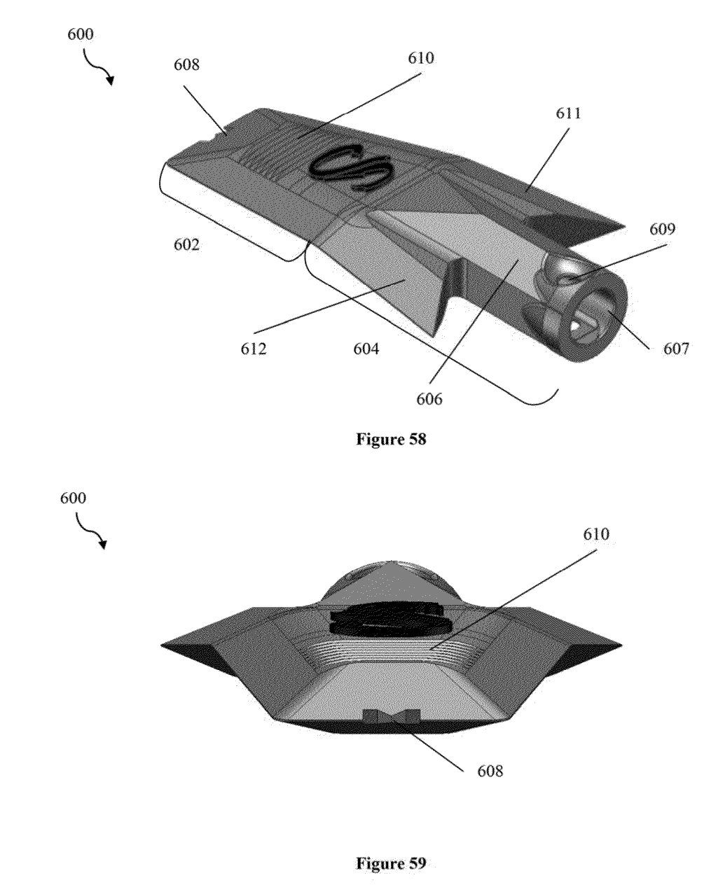

FIG. 58 shows an exemplary embodiment of an extractor tool attachment 600 having a first segment 602 and a second segment 604 having a universal connector 606. First segment 602 comprises a notch 608 on a front edge and a plurality of teeth 610 on top and bottom surfaces of the tool attachment. Extractor tool attachment can be used to pry, twist, punch, or strike walls, floors, and roofs. First segment 602 comprises notch 608 on a front edge, which divides the front edge into smaller regions for prying small areas. First segment 602 further includes plurality of teeth 610 (i.e., teeth grooves or textured portion) that provide a grip for various functions (e.g., prying). For example, a user can use extractor tool attachment 600 with a utility bar to pry a window open by using plurality of teeth 610 to grip a surface between the window frame and window so that the user can pull the window open. While extractor tool attachment 600 has plurality of teeth 610 on the top and bottom surfaces of first segment 602, it is contemplated that plurality of teeth are disposed on either the top surface or bottom surface of the tool attachment.

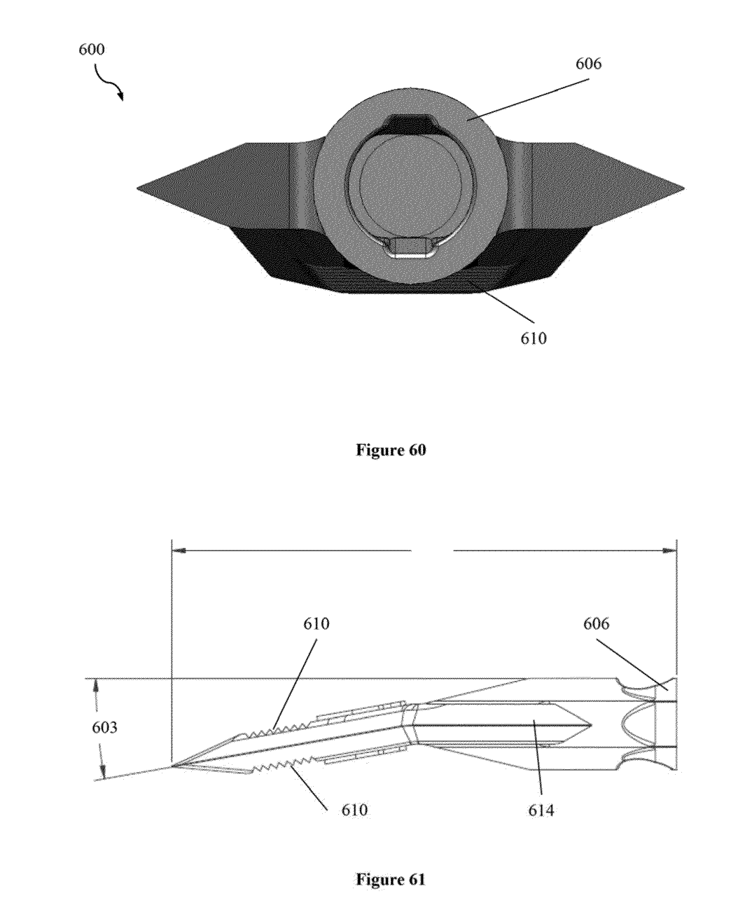

FIGS. 59 and 60 are a front and back view of extractor tool attachment 600 showing various features that were described above. FIG. 61 shows a side view of extractor tool attachment 600. It should be noted that first segment 602 and second segment 604 meet at an angle 603. In preferred embodiments, angle 603 is 10° to provide maximum leverage. However, other angles are contemplated, such 0°, 5°, 15°, 20° and other suitable angles that provide leverage for prying, twisting, punching, or striking walls, floors, and roofs. Furthermore, first segment 602 and second segment 604 can have a sharp edge along a first side, which will allow for various additional features (e.g., cutting, slicing, prying, etc.).

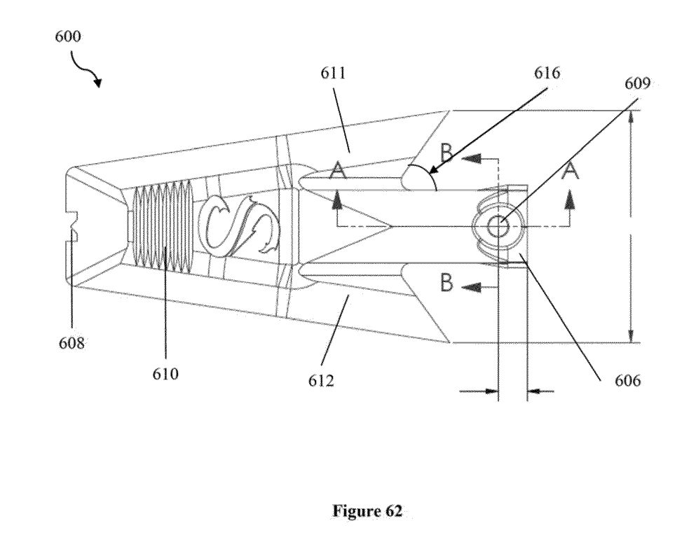

Extractor tool attachment 600 typically comprises a first wing 611 and a second wing 612 in second segment 604 as shown in FIG. 62. First and second wings 611 and 612 (e.g., ears) are disposed on opposite sides of a universal connector 606. It should be appreciated that first and second wings 611 and 612 form two points (i.e., tapered, sharp end) on opposite ends of the extractor tool attachment 600. The two points allow a user to pull objects once extractor tool attachment 600 has breached an object. For example, a user can poke a holes through the roof of a house using extractor tool attachment 600 and pull the shingles down to provide ventilation of the house during a fire.

Second segment 62 a cylindrically-shaped end portion, which is part of universal connector 606. First wing 611 forms an acute angle 616 relative to a longitudinal axis of the cylindrically-shaped end portion. However, other angles (e.g., right and obtuse) are also contemplated.

Viewed from FIG. 62, it should be appreciated that a tool width that narrows from the second segment to the first segment. The tool width can be defined the distance between the tip of first wing 611 to the tip of second wing 612. Viewed from the top perspective of FIG. 62, the tool width tapers as it approaches the front edge of first segment 602.

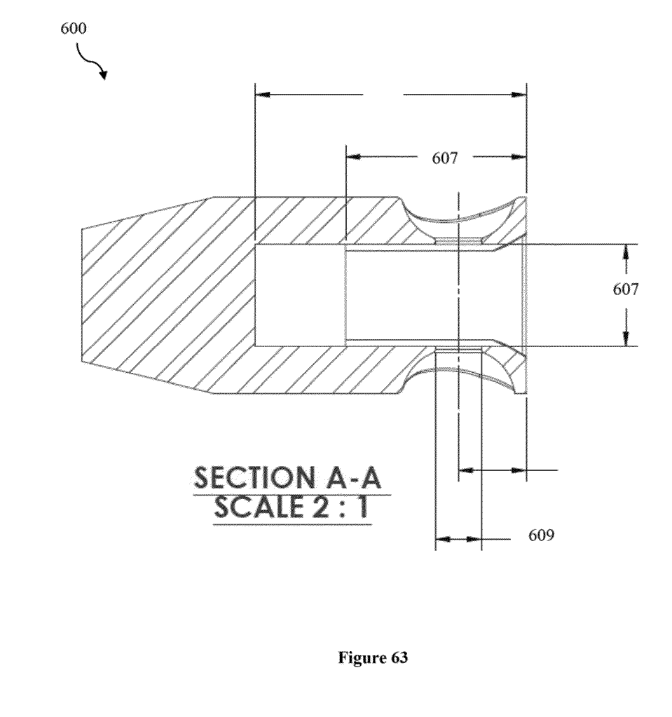

Universal connector 606 comprises a cavity 607 and a through hole 609 that is perpendicular to the depth of the cavity. FIG. 63 shows a cross section of a portion of universal connector 606 showing cavity 607 and through hole 609. As shown, cavity 609 has a depth that is parallel to a longitudinal axis of extractor tool attachment 600. Preferred embodiments include a universal connector that is sized and dimensioned to engage a utility bar (e.g., the utility bar described above).

Extractor tool attachment 600 can be composed of many suitable materials. For example, the first and second segments can be made of stainless steel. Polymers and other rigid materials are also contemplated as long as they can provide prying, twisting, punching, or striking functions.

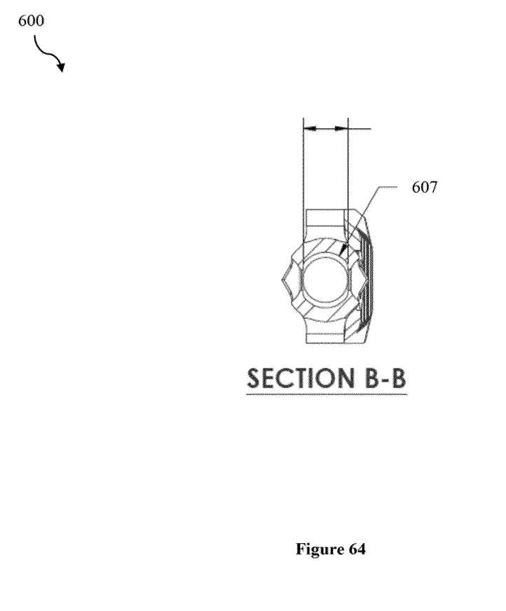

FIG. 64 is a cross section view along line B-B of FIG. 62 and shows cavity 607.

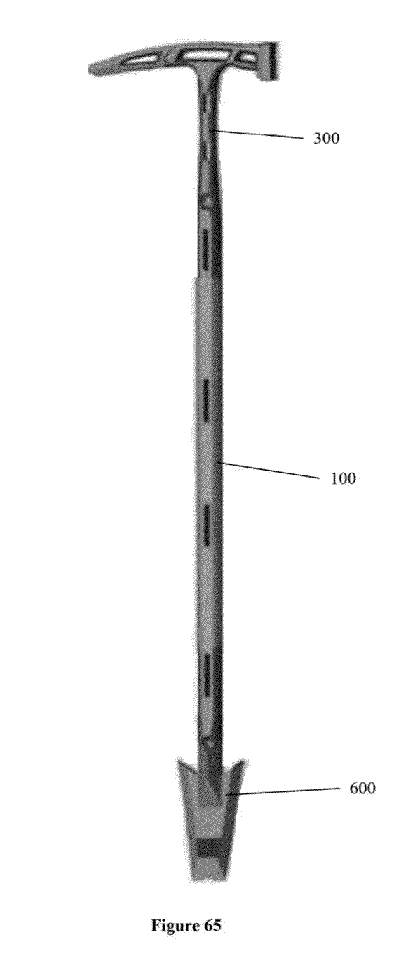

FIG. 65 shows extractor tool attachment 600 in combination with utility bar 100 and handle attachment 300.

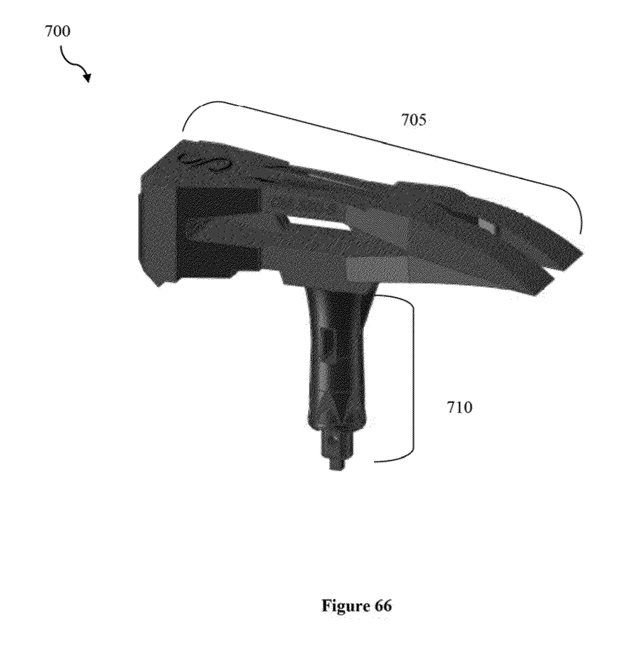

FIG. 66 is a perspective view of a breaching tool attachment 700. Tool 700 as a handle portion 705 and a stem portion 710.

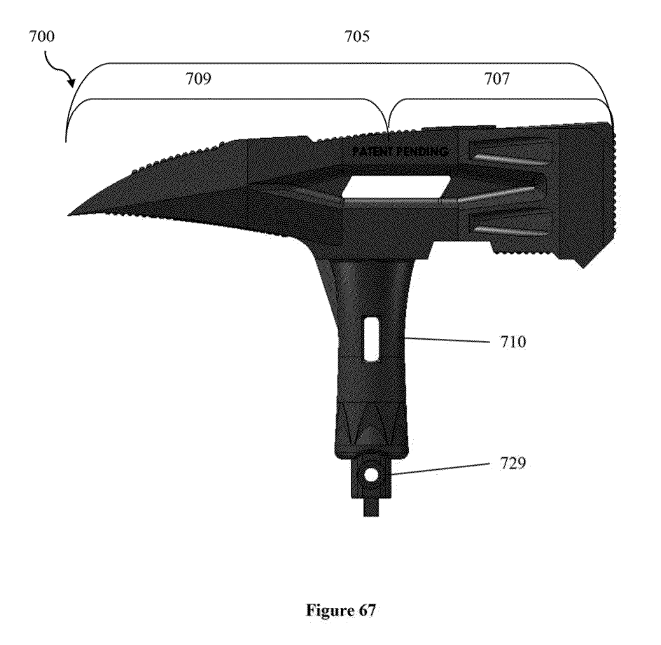

FIG. 67 is a left side view of breaching tool attachment 700. Handle portion 705 has a blunt end 707 and a claw end 709. Stem portion 710 has a universal connector 729 and a through hole 725.

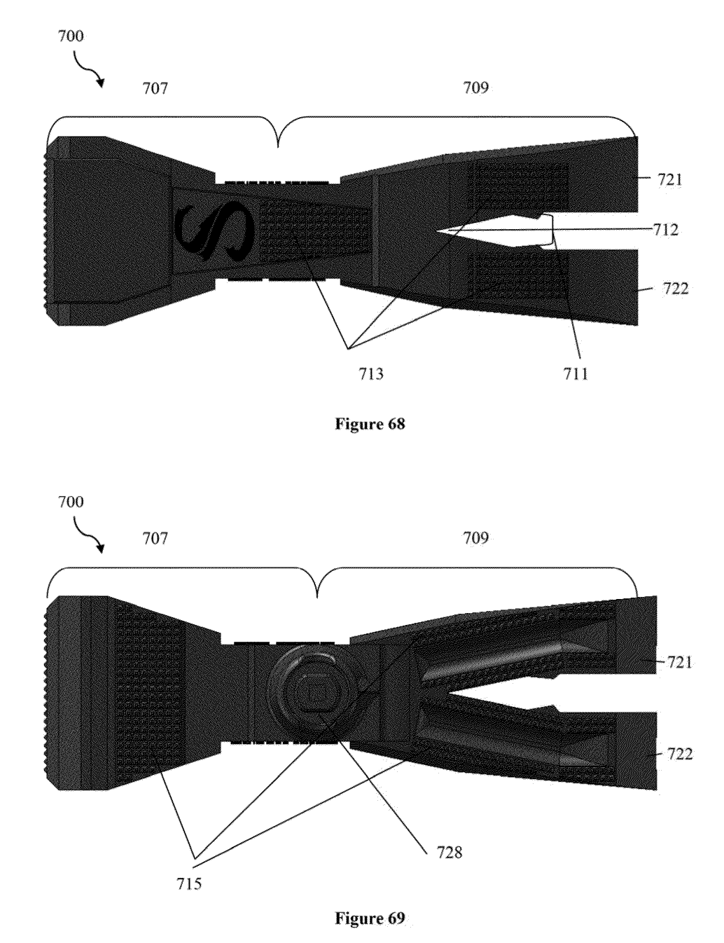

FIG. 68 is a top side view of breaching tool attachment 700. The top surface has a plurality of teeth 713 to provide frictional engagement. Claw end 709 has two fingers 721, 722 that meet to form a v-notch 712. Fingers 721, 722 also have a space that has notches 711.

FIG. 69 is a bottom view of breaching tool attachment 700. The bottom surface has plurality of teeth 715. In addition, fingers 721, 722 each have a recess. Universal connector 729 has an annular recess 728.

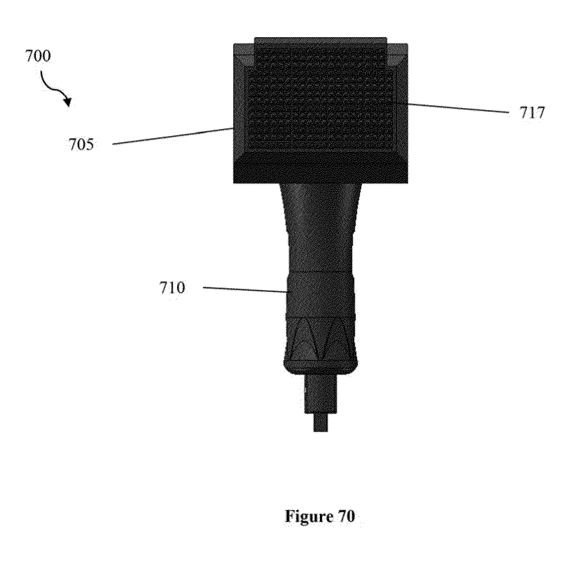

FIG. 70 is a front view of breaching tool attachment 700. Blunt end 707 of handle 705 has a blunt surface 717 with a plurality of teeth.

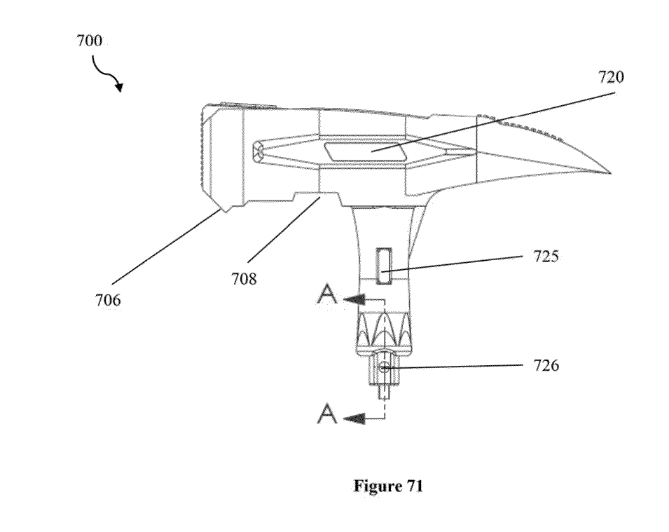

FIG. 71 is a right side view of the breaching tool attachment 700. Blunt end 707 has a sharp edge 706 on its underside surface, which can be used as a spanner wrench. The underside of blunt end 707 also has a recess 708 that can be used as a tool. Handle portion 705 also has a through hole 720, which can be used as an attachment point. Hole 720 also helps to reduce the weight of breaching tool attachment 700.

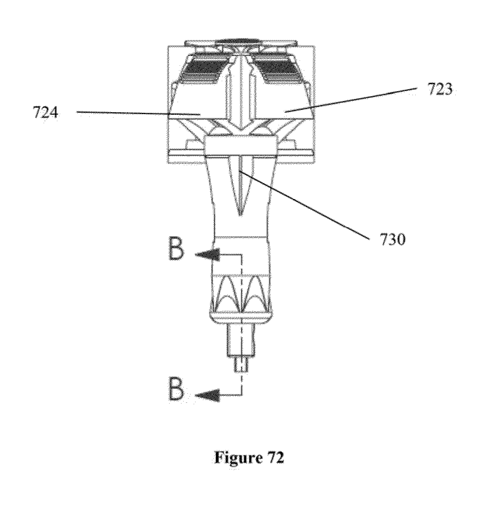

FIG. 72 is a back view of breaching tool attachment 700. The backside of stem portion 710 has a notch 730. The backside of fingers 721, 722 have sharp edges 723, 724, respectively.

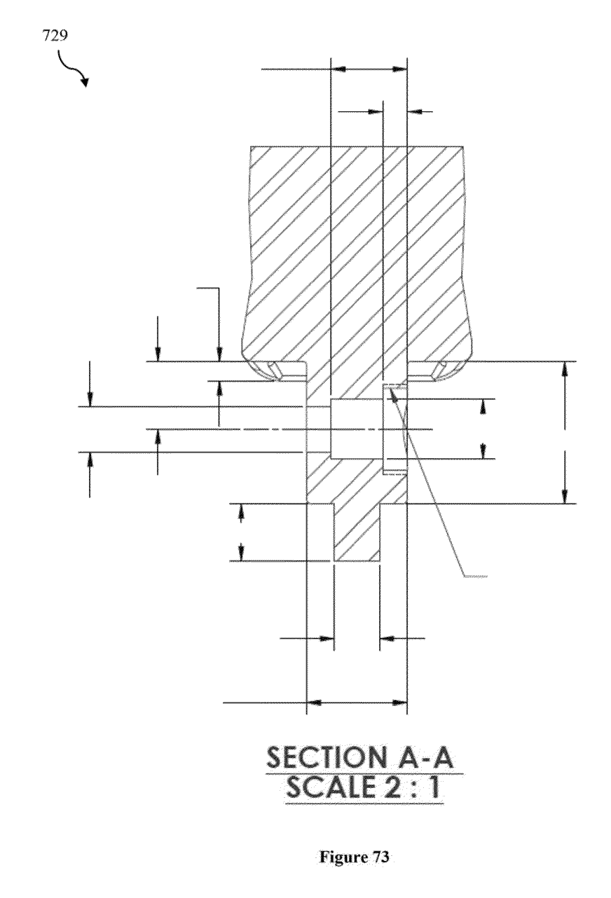

FIG. 73 is cross section view along line A-A of FIG. 71, showing the profile of the through hole 726 of universal connector 729.

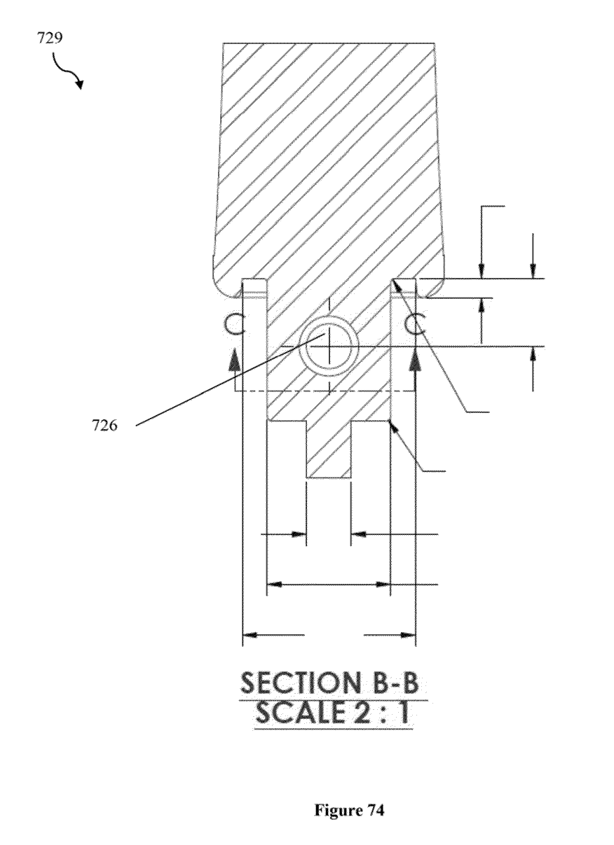

FIG. 74 is cross section view along line B-B of FIG. 72, showing through hole 726 of universal connector 729.

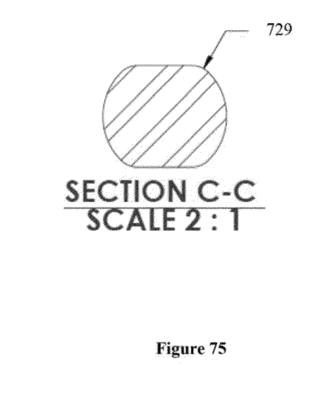

FIG. 75 is cross section view along line C-C of FIG. 74, showing the cross sectional shape (e.g., double d) of connector 729.

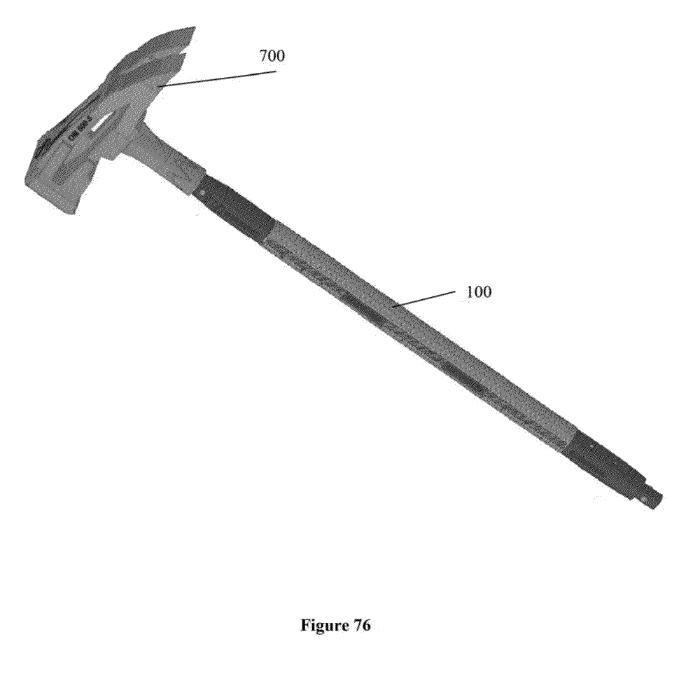

FIG. 76 is a perspective view of breaching tool 700 in combination with utility bar 100.

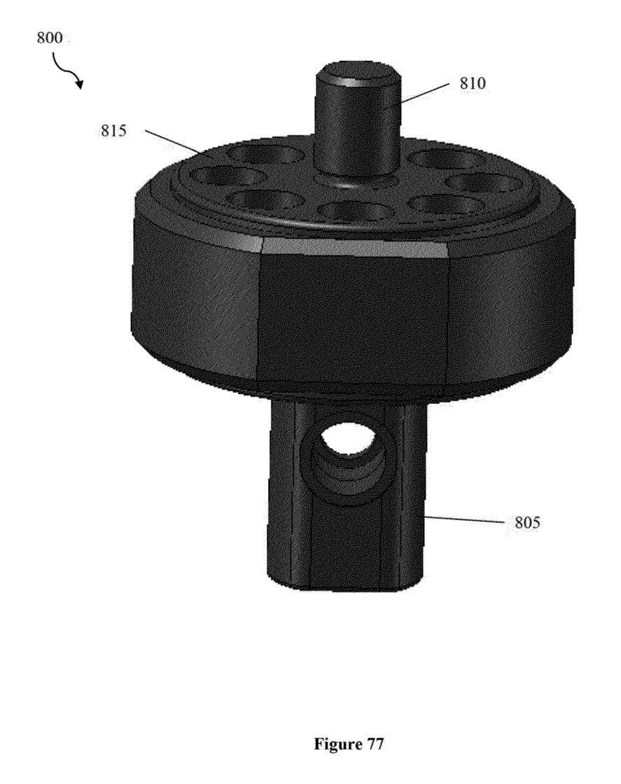

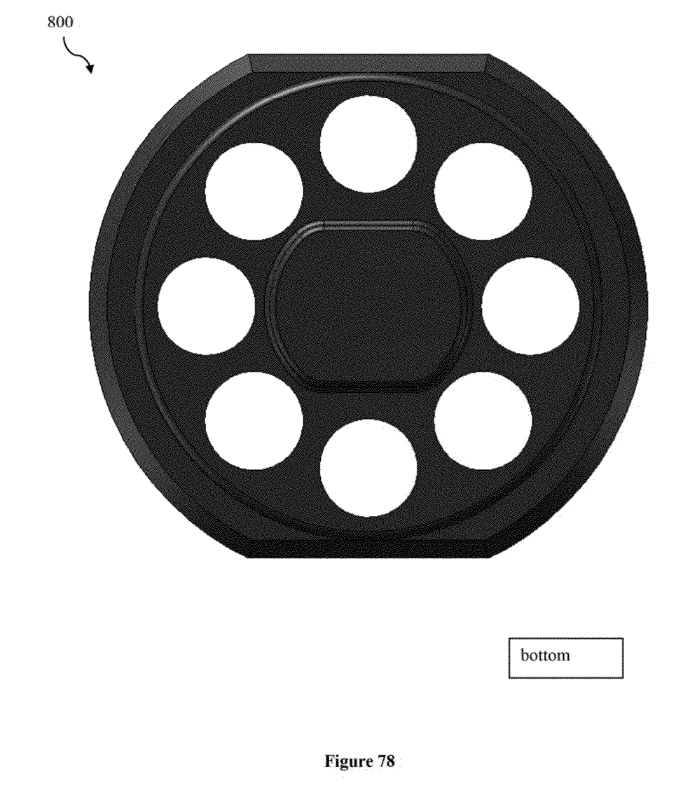

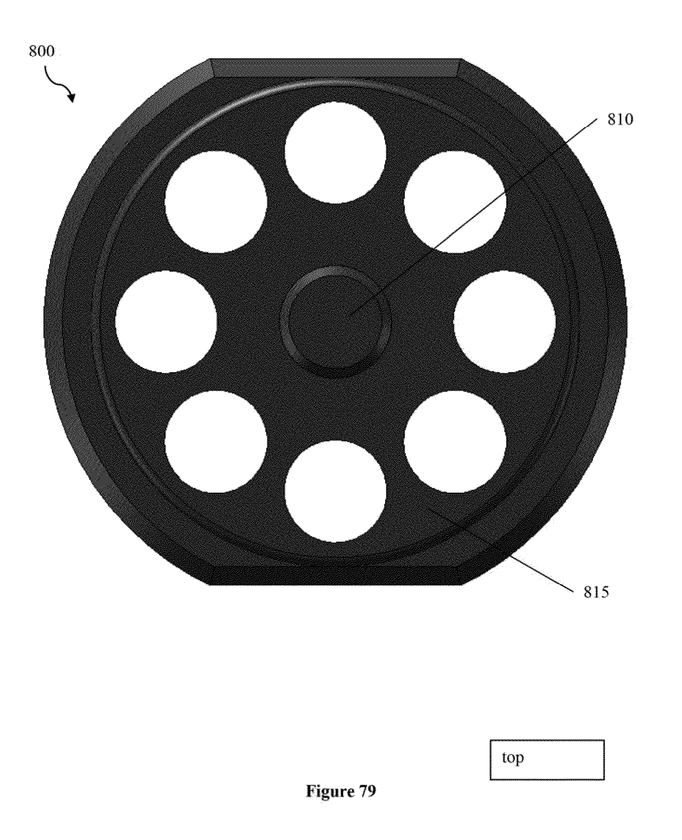

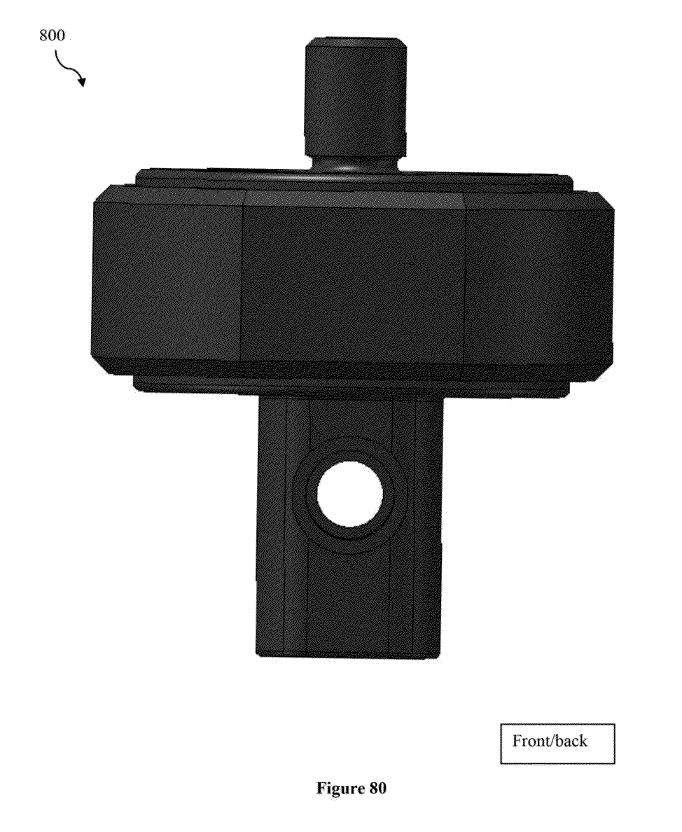

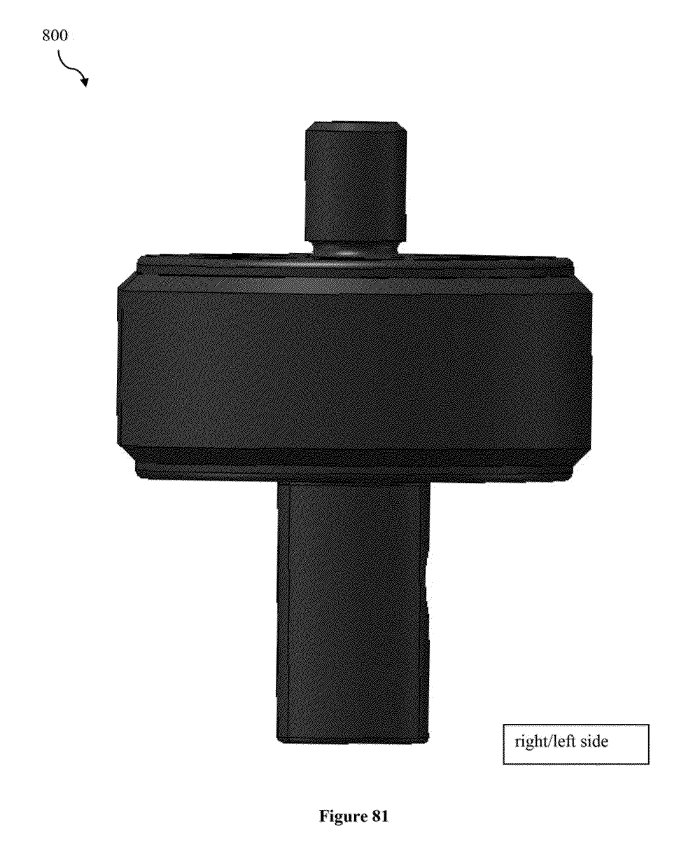

FIGS. 77 to 81 show various views of an adaptor attachment 800. Attachment 800 has a universal connector 805 that can attach to an end of bar 100. Attachment 800 also has a mounting surface 815 and a protrusion 810 for mounting devices (e.g., camera, shooting bracket, rifle, flashlight, etc.). Platform 815 has a plurality of through holes that serve as attachment points and decreases weight of adaptor attachment 800.

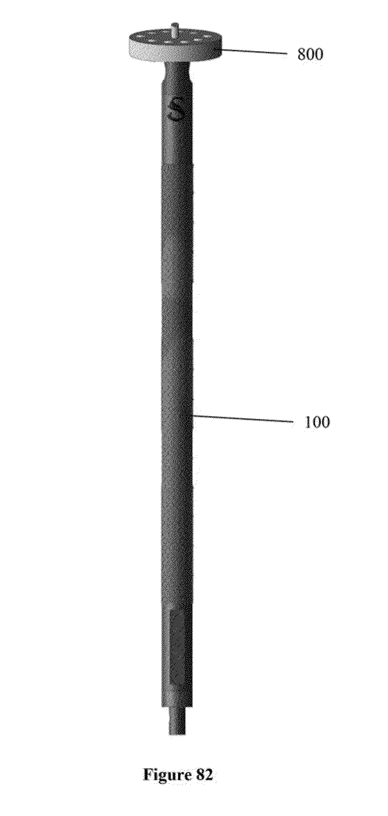

FIG. 82 shows adaptor attachment 800 in combination with utility bar 100.

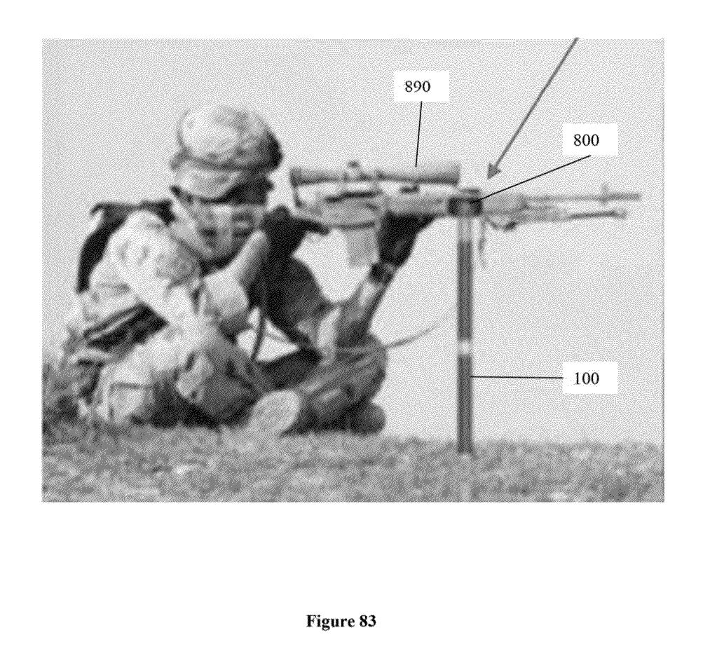

FIG. 83 shows adaptor attachment 800 in combination with utility bar 100, being uses as a rifle mount monopod.

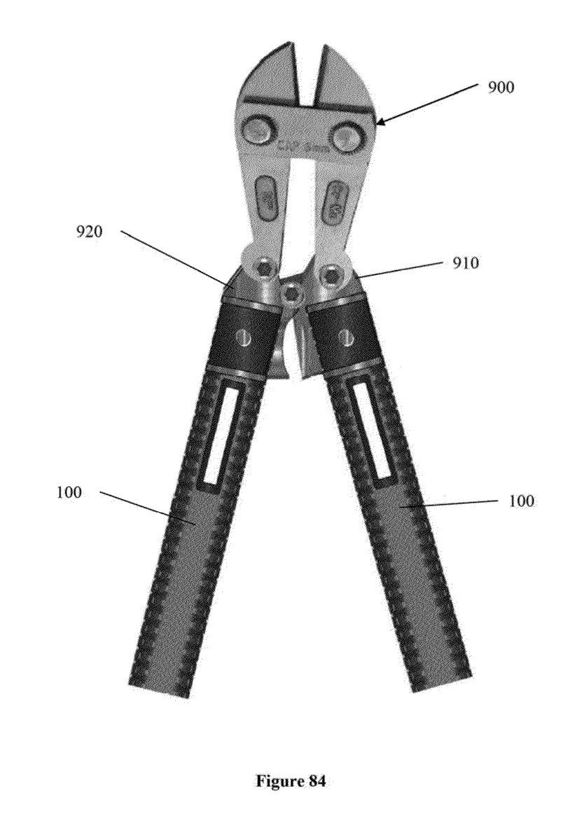

FIG. 84 shows a cutter tool attachment that has two blades rotatably coupled together. Each blade component has a universal connector 910, 920 that removably couples with bar 100.

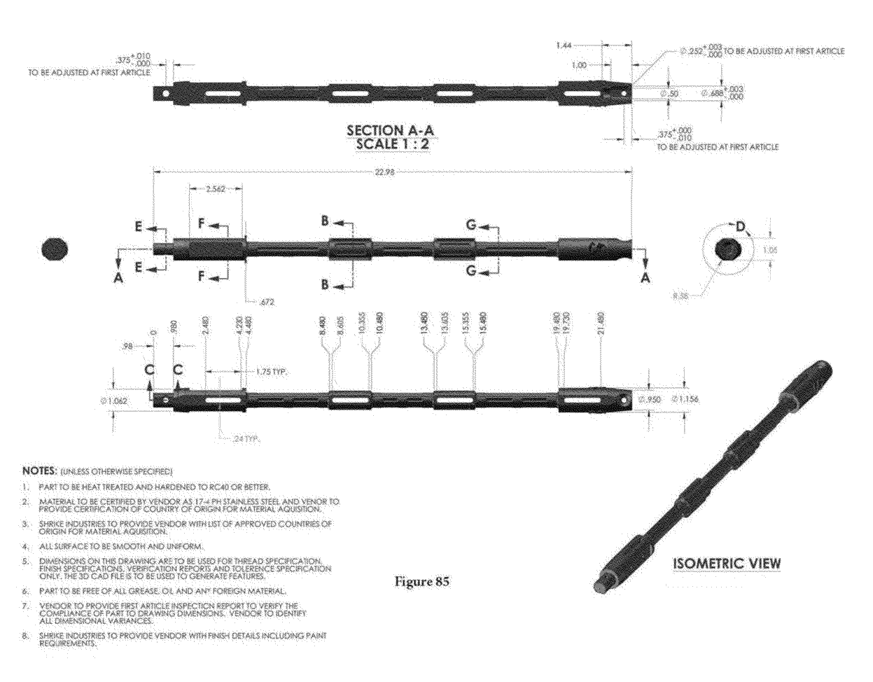

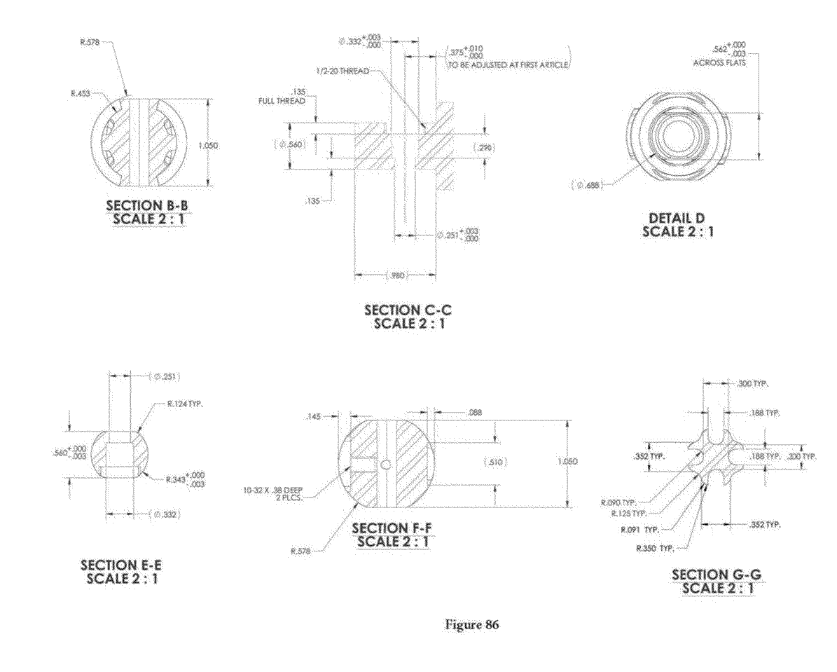

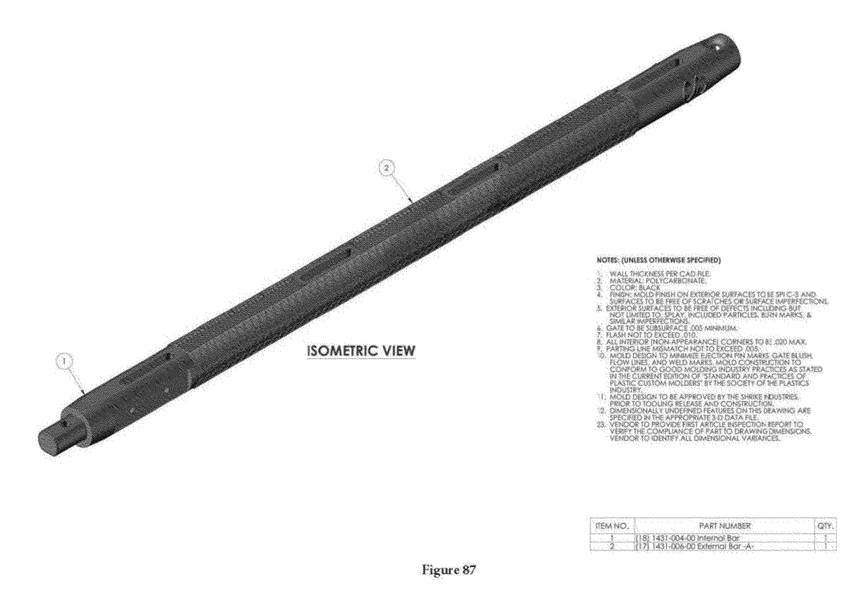

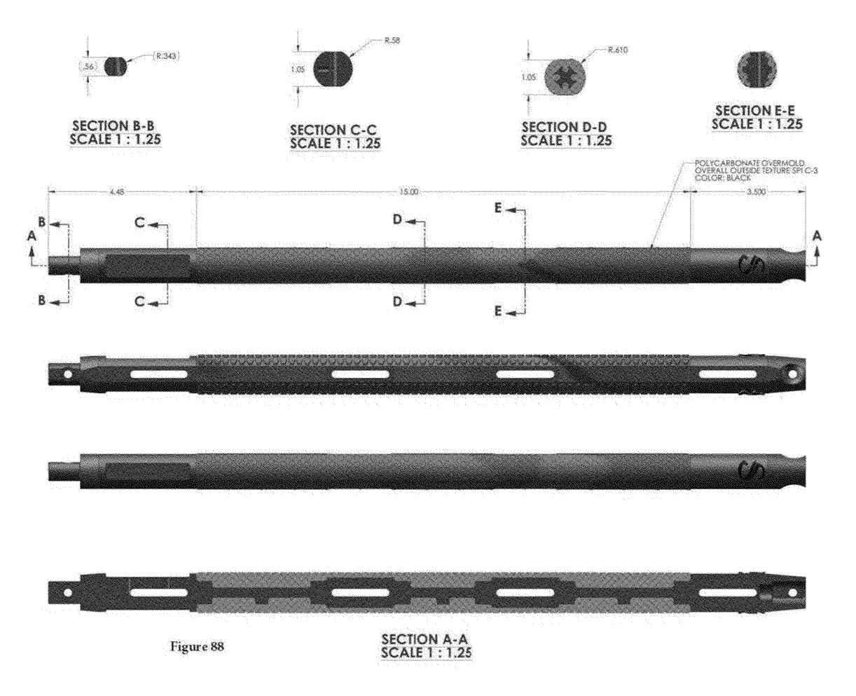

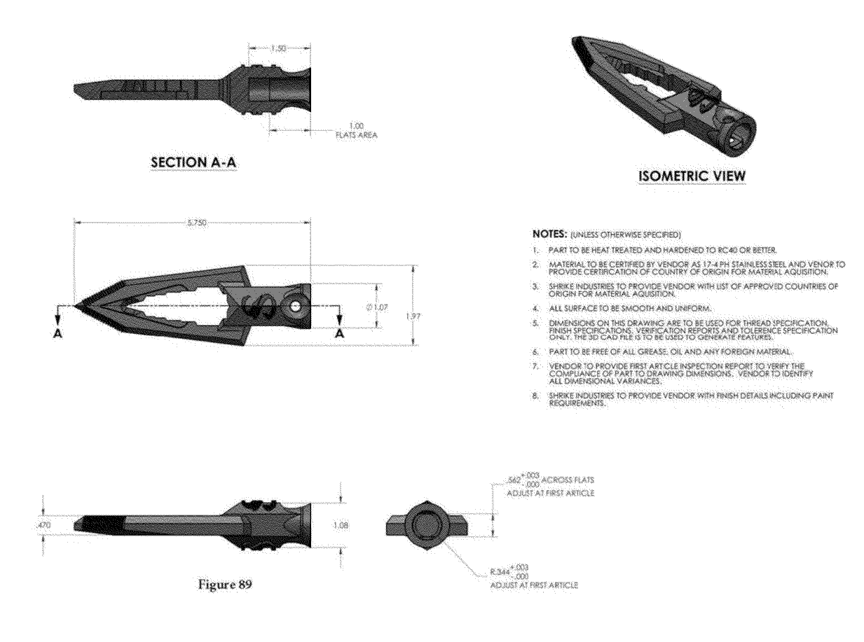

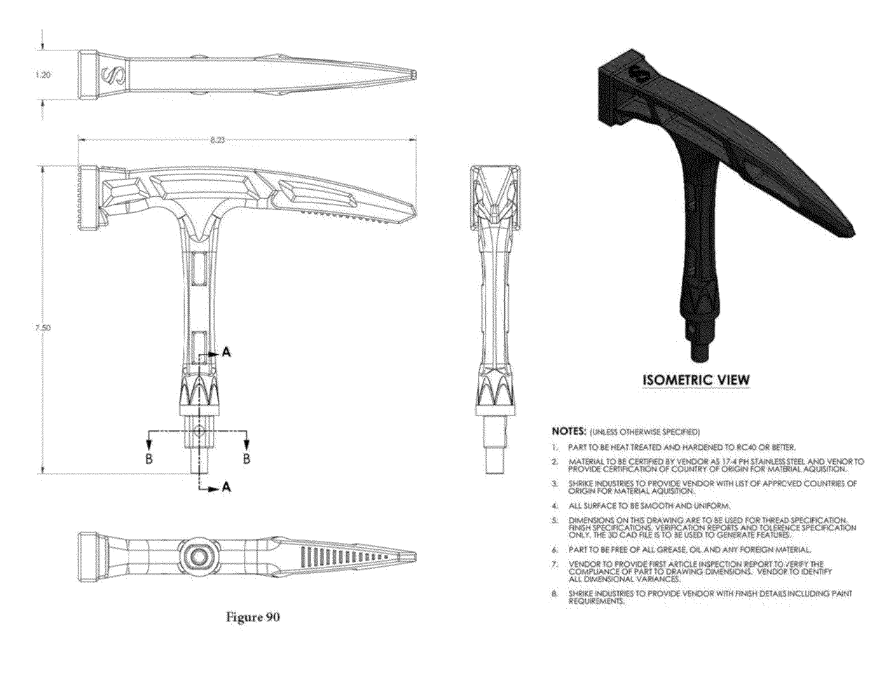

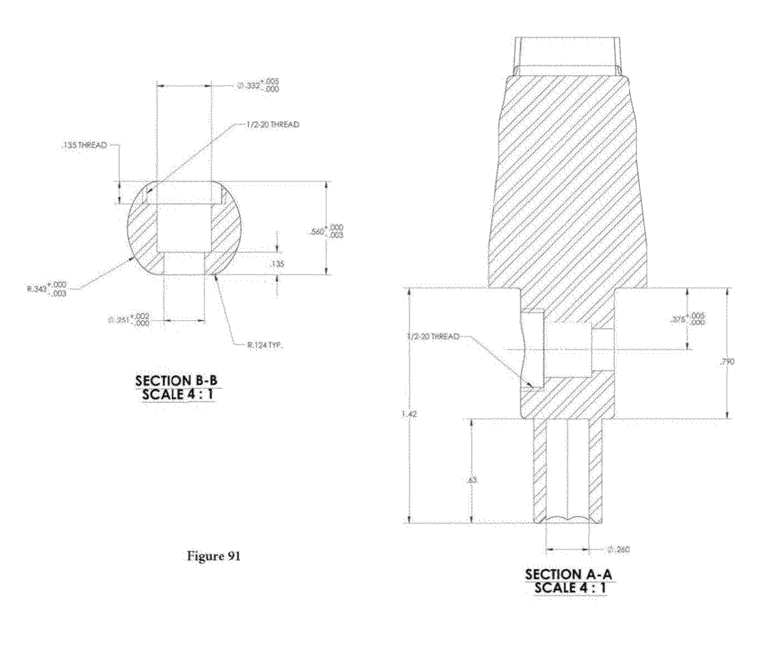

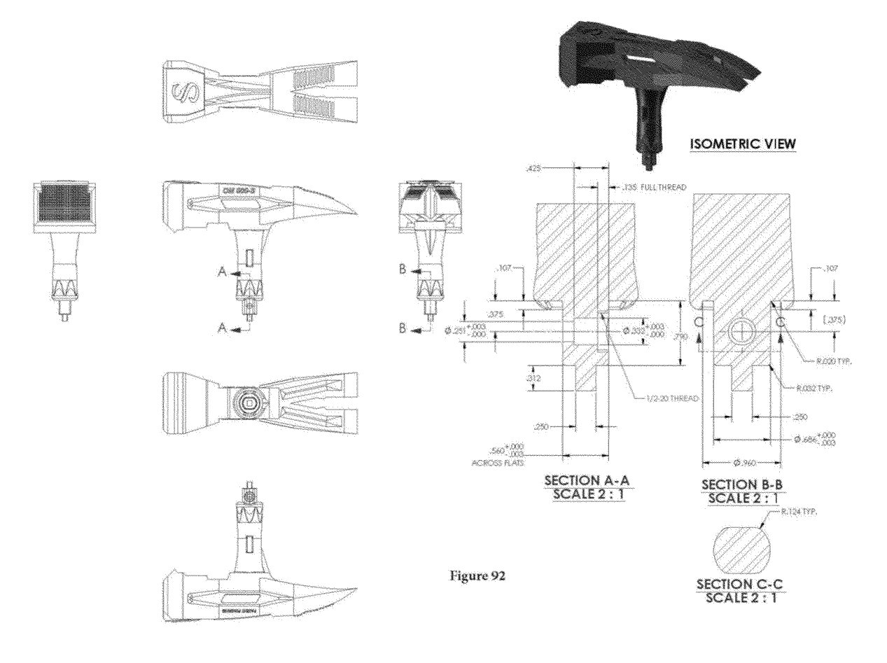

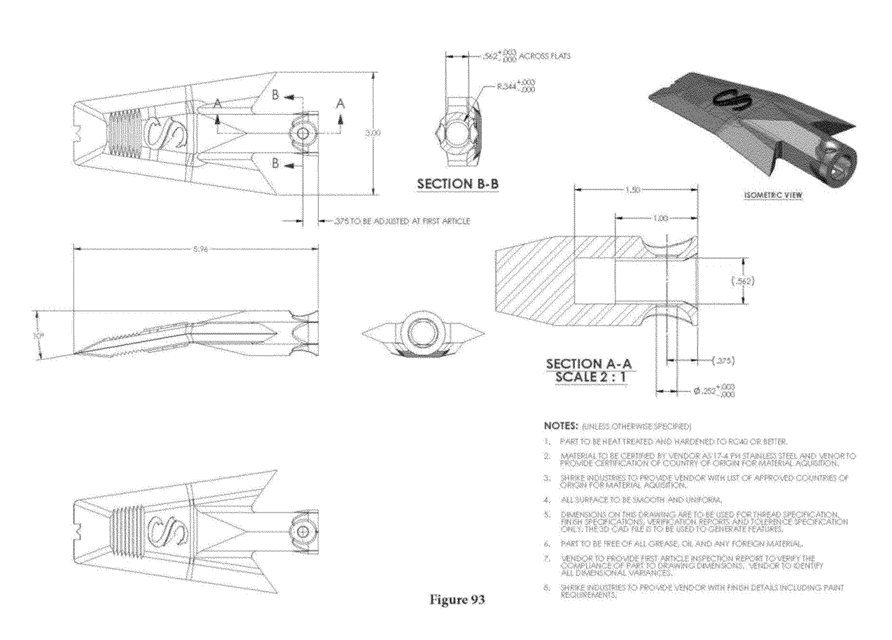

FIGS. 85-93 show schematics with dimensions for one embodiment of a utility bar, handle attachment, spear attachment, extractor attachment, and breaching tool attachment.

In some embodiments, the numbers expressing quantities of properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . . and N, the text should be interpreted as requiring only one element from the group, not A plus N, or B plus N, etc.

What is claimed is:

1. A utility bar comprising:
an elongated member having a first end and a second end coupled by a middle section;
wherein the first end comprises a female mechanical connector;
wherein the second end comprises a male mechanical connector that is sized and dimensioned to mate with the female mechanical connector;
wherein the middle section has a first through hole and a second through hole; and
wherein the middle section has a plurality of recessed portions.

2. The utility bar of claim 1, further comprising an overmold made of a rubber and sized and dimensioned to cover at least a portion of the middle section.

3. The utility bar of claim 2, wherein the overmold has a plurality of frictional elements for improving grip.

4. The utility bar of claim 2, wherein the elongated member and overmold have a general cylindrical shape.

5. The utility bar of claim 4, wherein the general cylindrical shape includes a first flat surface on a first side of the elongated member that extends along a majority of the length of the elongated member.

6. The utility bar of claim 5, wherein the general cylindrical shape includes a second flat surface on a second side of the elongated member and opposite to the first side, and that extends along a majority of the length of the elongated member.

7. The utility bar of claim 6, wherein the female connector comprises a cavity having a cross section that is generally circular except for two flat opposing sides.

8. The utility bar of claim 7, wherein the cavity is accessible via an opening.

9. The utility bar of claim 8, wherein the cavity has a depth that is parallel to the longitudinal axis of the bar.

10. The utility bar of claim 9, wherein the male connector comprises a protrusion having a cross section that is generally circular except for two flat opposing sides.

11. The utility bar of claim 10, wherein the two flat opposing sides of the male and female connectors are on the first and second sides of the bar. (i.e., they align with the two flat surfaces extending along the majority of the first and second sides).

12. The utility bar of claim 1, further comprising a plurality of recessed portions disposed on all sides of the middle section of the elongated member.

13. The utility bar of claim 12, wherein the plurality of recessed portions are disposed on at least 80% of the length of the middle section of the elongated member.

14. The utility bar of claim 13, wherein at least a portion of the middle section of the elongated member has a first cross-sectional shape comprising a cross.

15. The utility bar of claim 14, wherein the first cross sectional shape has a recessed portion at each of the four ends of the cross.

16. The utility bar of claim 15, wherein the cross of the first cross-sectional shape is symmetrical about the longitudinal access of the elongated member.

17. The utility bar of claim 16, wherein at least a portion of the middle section of the elongated member has a second cross-sectional shape comprising a cross with a recessed portion at only two of the four ends of the cross, wherein the two ends having a recessed portion are adjacent to one another.

18. The utility bar of claim 1, further comprising an overmold made of at least two distinct layers of material that have two different hardness values.

19. The bar of claim 1, wherein the bar has a weight no greater than 2.5 lbs and a flexural strength (3 point bending) of at least 42 psi.

20. A kit comprising:
the multi-purpose bar of claim 1; and
at least first and second tool attachments configured to removeably couple with the elongated member.

21. The kit of claim 20, wherein the first tool attachment comprises a helmet counterweight that is shaped to form a shovel head.

22. The kit of claim 20, wherein the first and second attachments are configured to removeably couple to one another.

23. A handle attachment for a multi-purpose utility bar comprising:
a t-shaped member having a handle portion and a stem portion extending perpendicularly from the handle portion;
wherein the handle portion comprises a blunt end, a pointed end, and one or more through holes;
wherein the pointed end is longer than the blunted end;
wherein the pointed end has a concave top surface; and
wherein the stem portion comprises a universal connector and a first through hole.

24. The handle attachment of claim 23, wherein the first through hole on the stem portion has a rectangular shape.

25. The handle attachment of claim 24, wherein the first through hole on the stem portion extends from the right side to the left side of the t-shaped member.

26. The handle attachment of claim 25, further comprising a second through hole on the stem portion.

27. The handle attachment of claim 23, wherein a front-most surface of the blunt end has a plurality of teeth.

28. The handle attachment of claim 23, wherein an underside surface of the blunt end has a notch facing the stem portion.

29. The handle attachment of claim 23, wherein an underside surface of the pointed end has a plurality of grooves.

30. The handle attachment of claim 23, wherein the universal connector comprises a protrusion having two balls on opposing sides of the protrusion and biased outwardly.

31. The handle attachment of claim 23, wherein the stem portion has an annular recess surrounding the universal fastener.

32. The handle attachment of claim 23, further comprising a hex nut socket extending from the universal connector.

33. The handle attachment of claim 23, wherein the stem portion meets the handle portion at a contoured surface.

34. The handle attachment of claim 23, wherein the universal connector is sized and dimensioned to detachably mate with a universal connector on a utility bar in a left-handed configuration and a right handed configuration.

35. A shovel head counterweight attachment for counterbalancing a helmet attachment on a helmet, the helmet having a first curvature and a second curvature, comprising:
a concave member having a first major surface, a second major surface, a length, and a width;
wherein a curvature of the width of the concave member matches the first curvature of the helmet;
wherein a curvature of the length of the concave member matches the second curvature of the helmet; and
wherein the width gradually decreases going from a first end of the length to a second end of the length.

36. The shovel head counterweight attachment of claim 35, wherein the concave member has a mass of about 2.1 lbs.

37. The shovel head counterweight attachment of claim 35, wherein the length is about 6.375 inches.

38. The shovel head counterweight attachment of claim 35, wherein the width at the first end is about 6.367 inches.

39. The shovel head counterweight attachment of claim 35, wherein the width at the second end is about 2.663 inches.

40. The shovel head counterweight attachment of claim 35, further comprising a hook and loop fastener attached to the first major surface of the concave member.

41. The shovel head counterweight attachment of claim 35, further comprising a first universal fastener on the second major surface of the concave member for removably attaching a utility bar in a first orientation.

42. The shovel head counterweight attachment of claim 41, further comprising a second universal fastener on the second major surface of the concave member for removably attaching the utility bar in a second orientation.

43. The shovel head counterweight attachment of claim 35, wherein the concave member has a maximum height of about 2.999 inches.

44. The shovel head counterweight attachment of claim 35, wherein the concave member has a sharpened front edge.

45. The shovel head counterweight attachment of claim 44, wherein the concave member has a corrugated side edge for sawing wood.

46. A spear tool attachment, comprising:
a first end portion comprising a point;
a second end portion comprising a universal connector;
a intermediate portion having a stepped opening, wherein the intermediate portion is between the first end portion and the second end portion;
wherein the stepped opening has a plurality of steps that define a plurality of distinct widths; and
wherein the stepped opening has a first side and a second side that intersect near at an acute angle near the first end portion.

47. The spear tool attachment of claim 46, wherein the first end portion comprises teeth on a third side and a fourth side.

48. The spear tool attachment of claim 46, wherein the universal connector comprises a cavity and a through hole that is perpendicular to the cavity.

49. The spear tool attachment of claim 46, wherein the plurality of distinct widths <<explain that a single step is used to engage the hex nut/gas valve as opposed all the steps>> are sized and dimensioned to engage a ⅝ inch, ½ inch, 7/16 inch, ⅜ inch, and 5/16 inch hex nut.

50. The spear tool attachment of claim 46, wherein the stepped opening is further sized and dimensioned to engage a rectangular-shaped shutoff value.

51. The spear tool attachment of claim 46, wherein the intermediate portion has an intermediate portion width that narrows from the second end portion to the first end portion.

52. The spear tool attachment of claim 51, wherein the intermediate portion and the first end portion meet at an obtuse angle.

53. The spear tool attachment of claim 46, wherein the universal connector is cylindrically-shaped.

54. The spear tool attachment of claim 46, wherein the universal connector is sized and dimensioned to engage a utility bar.

55. The spear tool attachment of claim 46, wherein the first end portion, intermediate portion, and second end portion are stainless steel.

56. The spear tool attachment of claim 46, wherein the intermediate portion comprises a v-shaped recess on a top surface of the spear tool attachment and that is concentric with a profile of the first end portion and intermediate portion.

57. The spear tool attachment of claim 46, wherein the first end portion and the intermediate portion have a sharp edge along a first side.

58. The spear tool attachment of claim 46, wherein the plurality of steps comprises a first stepped side and a second stepped side that is opposite to the first stepped side relative to the longitudinal axis of the intermediate portion.

59. The spear tool attachment of claim 58, wherein the stepped opening comprises a pair of opposing right-angle notches near the second end portion and separated by a first width.

60. The spear tool attachment of claim 59, wherein the first width of the pair of opposing right-angle notches is equal to one of the plurality of distinct widths.

61. An extractor tool attachment, comprising:
a first segment and a second segment that meet at a first angle;
a tool width that narrows from the second segment to the first segment; and
wherein the second segment comprises a universal connector.

62. The extractor tool attachment of claim 61, the angle is 10 degrees.

63. The extractor tool attachment of claim 61, wherein the first segment comprises a notch on a front edge.

64. The extractor tool attachment of claim 61, wherein the first segment comprises a plurality of teeth on at least one of a top surface and a bottom surface of the tool attachment.

65. The extractor tool attachment of claim 61, wherein the second segment comprises a cylindrically-shaped end portion.

66. The extractor tool attachment of claim 65, wherein the second segment comprises a first and second wing.

67. The extractor tool attachment of claim 66, wherein the first wing forms an acute angle relative to a longitudinal axis of the cylindrically-shaped end portion.

68. The extractor tool attachment of claim 61, wherein the universal connector is sized and dimensioned to engage a utility bar.

69. The extractor tool attachment of claim 61, wherein the first and second segments are made of stainless steel.

70. The extractor tool attachment of claim 61, wherein the first segment and the second segment have a sharp edge along a first side.

71. The extractor tool attachment of claim 61, wherein the universal connector comprises a cavity and a through hole that is perpendicular to the depth of the cavity.

72. A breaching tool attachment for a multi-purpose utility bar, comprising:
a t-shape member having a head portion and stem portion extending from the head portion;
wherein the head portion comprises a blunt end, a claw end, and one or more through holes;
wherein the front-most surface of the blunt end comprises a blunt surface;
wherein the claw end comprises two fingers that meet to form a v-notch and each finger having a sharp edge;
wherein the stem portion comprises a universal connector and at least one through hole; and
wherein the head portion has a first recess on a first side of the head portion and a second recess on a second side of the head portion.

73. The breaching tool attachment of claim 72, wherein the universal connector comprises a protrusion extending from an end of the stem portion parallel to the longitudinal axis of the stem portion.

74. The breaching tool attachment of claim 72, wherein a top surface of the head portion comprises a plurality of teeth.

75. The breaching tool attachment of claim 72, wherein the blunt surface comprises a plurality of teeth.

76. The breaching tool attachment of claim 72, wherein the underside surface of the blunt end comprises a plurality of teeth.

77. The breaching tool attachment of claim 72, wherein the underside surface of the blunt end comprises a sharp edge.

78. The breaching tool attachment of claim 72, wherein the underside surface of the blunt end comprises a recessed slot extending the entire width of the blunt end.

79. The breaching tool attachment of claim 72, wherein the first and second recesses on the head portion surround the through-hole on the head portion.

80. The breaching tool attachment of claim 79, wherein the first and second sides of the head portion each comprise two additional recesses disposed on the blunt end.

81. The breaching tool attachment of claim 72, wherein the underside surface of each of the fingers of the claw end of the head portion has a recess.

82. The breaching tool attachment of claim 81, wherein each of the recesses on the underside surface of the fingers is surrounded by a plurality of teeth.
